(19) United States
(12) Patent Application Publication
(10) Pub. No.: US 2026/0041607 A1
(43) Pub. Date: Feb. 12, 2026

(54) FLUID CONTAINERS AND CONTAINER SYSTEMS WITH DRY BREAK PORTS

(71) Applicant: B. Braun Melsungen AG, Melsungen (DE)

(72) Inventors: James Albert Nixon, Allentown, PA (US); John Trung Nguyen, Garden Grove, CA (US); Julien Verrey, Jouxtens-Mézery (CH); Sandro Solarte Salonga, Tustin, CA (US); Neil Alex Korneff, Yorba Linda, CA (US); Raphaël Vallotton, Blonay (CH)

(21) Appl. No.: 18/796,108

(22) Filed: Aug. 6, 2024

(51) Int. Cl. A61J 1/10

(52) U.S. Cl. CPC A61J 1/10

(57) ABSTRACT

A fluid container has a container body defining an interior volume, a port providing access to the interior volume, and a dry break attached to the port for forming a dry break coupling with a second device. The fluid container can be part of a closed fluid transfer system that includes the fluid container and a closed system transfer device. The dry break on the fluid container defines a first passage in fluid communication with the port. A first septum seals the first passage. The closed system transfer device has a housing configured to receive at least a portion of the dry break. A carrier is movable in the housing. The carrier defines a second passage and includes a second septum that seals the second passage. A cannula is at least partially disposed in the second passage.

### FIELD

The present disclosure relates to devices for safely transferring hazardous drugs between containers in a closed system that prevents the inflow of contaminants into the system, and prevents the release of hazardous vapors and liquids from the system into the environment and/or onto the applicant.

### BACKGROUND

Medications are commonly administered to patients intravenously from sterile fluid containers. The fluid containers can be in the form of flexible containers or bags having one or more ports. A port can be used to fill the fluid container with a medication. The same port or a different port can be used to administer medication from the fluid container to the patient.

Known fluid containers with ports work well for administering nutrients, solutions and non-hazardous drugs directly to patients. Unfortunately, known fluid containers with ports are neither safe nor suitable for administering hazardous drugs, such as drugs used in cancer therapy. The ports have no mechanism for preventing the release of hazardous liquids and vapors when the ports are connected to and disconnected from syringes and patient sets. Therefore, if the interior of a fluid container is at a higher pressure than ambient pressure, liquids and vapors in the fluid container can be released from the port when the port is connected to and disconnected from other devices. This can expose healthcare workers to hazardous compounds. The ports also lack safeguards for preventing contaminants from entering the container when the ports are connected to and disconnected from syringes and patient sets. This increases the risk of drug contamination.

### SUMMARY

In one exemplary embodiment, a fluid container includes a container body defining an interior volume and a port that provides access to the interior volume from outside of the container body. The port includes a dry break for forming a dry break coupling with a second device.

In the same embodiment or in a different embodiment, the dry break includes an adaptor body and a septum configured to form the dry break coupling with the second device.

In the same embodiment or in a different embodiment, the port includes a membrane that fluidly separates the interior volume of the container body from the septum.

In the same embodiment or in a different embodiment, the membrane is directly adjacent to the membrane.

In the same embodiment or in a different embodiment, the adaptor body includes a housing portion having a rectangular cross section.

In the same embodiment or in a different embodiment, the adaptor body includes a chamber adjacent to the housing portion, the chamber defining a seat for the septum.

In the same embodiment or in a different embodiment, the adaptor body includes a first end with a first opening, a second end with a second opening opposite the first opening, and a passage extending from the first opening to the second opening.

In the same embodiment or in a different embodiment, the passage includes a first section adjacent the first opening that defines a socket and a second section adjacent the second opening that defines the chamber.

In the same embodiment or in a different embodiment, the port includes a plug that is received in the socket.

In the same embodiment or in a different embodiment, the plug has an outer geometry that conforms to a frustum of a cone.

In the same embodiment or in a different embodiment, the socket defines a tapered inner wall that conforms to the outer geometry of the plug.

In the same embodiment or in a different embodiment, the adaptor body includes a longitudinal axis, a first side and a second side opposite the first side.

In the same embodiment or in a different embodiment, the first side includes a first ledge and the second side includes a second ledge opposite the first ledge.

In the same embodiment or in a different embodiment, the fluid container includes a second port that provides access to the interior volume from outside of the container body.

In the same embodiment or in a different embodiment, the second port is not a dry break.

In the same embodiment or in a different embodiment, the second port includes a dry break.

In the same embodiment or in a different embodiment, the port and the dry break are injection molded and connected to each other in a rigid manner.

In the same embodiment or in a different embodiment, the fluid container includes a flexible tube having a first end and a second opposite the first end, wherein the first end of the flexible tube is directly welded to the container body and the second end is directly connected to the dry break.

In another embodiment, a closed fluid transfer system includes a fluid container having a container body defining an interior volume, a port providing access to the interior volume from outside of the container body, and a dry break defining a first passage in fluid communication with the port, the dry break including a first septum that seals the first passage.

In the same embodiment or in a different embodiment, the closed fluid transfer system also includes a closed system transfer device having a housing defining an interior space configured to receive at least a portion of the dry break, a carrier movable in the interior space of the housing, the carrier defining a second passage and including a second septum that seals the second passage, and a cannula at least partially disposed in the second passage, the cannula having a cannula opening.

In the same embodiment or in a different embodiment, the carrier is axially displaceable in the interior space, and relative to the cannula, by the dry break when the dry break is inserted into the housing.

In the same embodiment or in a different embodiment, the carrier is axially displaceable within the housing between a first position, in which the first septum abuts the second septum and the cannula opening is sealed inside the second passage, and a second position, in which the first septum abuts the second septum and the cannula opening is in fluid communication with the first passage of the dry break to connect the fluid container and the closed system transfer device in a fluid path open state.

In the same embodiment or in a different embodiment, the housing includes a first end and a second end opposite the first end, the first end adapted to receive the portion of the dry break, and the second end configured to connect to at least one fluid reservoir.

In the same embodiment or in a different embodiment, the housing includes a first end and a second end opposite the first end, the first end adapted to receive the portion of the dry break, and the second end configured to connect to a patient line.

In the same embodiment or in a different embodiment, the closed fluid transfer system also includes a second port that provides access to the interior volume from outside of the container body.

### BRIEF DESCRIPTION OF THE DRAWINGS

The drawing figures depict one or more implementations by way of example only, not by way of limitations. In the figures, like reference numerals can refer to the same or similar elements.

FIG. 1 is a schematic view of a system according to one embodiment, which features a fluid container with a dry break that forms a first dry break coupling with a fluid reservoir and a second dry break coupling with a patient set.

FIG. 2 is a perspective view of the fluid container of FIG. 1.

FIG. 3 is an exploded perspective view of the fluid container of FIG. 1.

FIG. 4 is a truncated front view of a portion of the fluid container of FIG. 1 shown in cross section.

FIG. 5 is a truncated side view of a portion of the fluid container of FIG. 1 shown in cross section.

FIG. 6A is a schematic view of a system according to another embodiment, which features a fluid container, a first device, and a second device, the fluid container having a first port with a dry break for connection with the first device, and a second port without a dry break for connection with the second device.

FIG. 6B is a schematic view of a system according to another embodiment, which features the fluid container and first device of FIG. 6A, and a third device for connection with the second port without the dry break.

FIG. 7 is a truncated perspective view of the fluid container of FIGS. 6A and 6B.

FIG. 8 is a truncated and exploded perspective view of the fluid container of FIG. 7.

FIG. 9 is a truncated front view of a portion of the fluid container of FIG. 7 shown in cross section.

FIG. 10 is a truncated perspective view of a fluid container according to another embodiment, which features a first port with a dry break and a second port without a dry break.

FIG. 11 is truncated and exploded perspective view of the fluid container of FIG. 10.

FIG. 12 is a truncated front view of a portion of the fluid container of FIG. 10 shown in cross section.

FIG. 13 is a truncated perspective view of a fluid container according to another embodiment, which features a first port with a dry break and a second port without a dry break.

FIG. 14 is a truncated and exploded perspective view of the fluid container of FIG. 13.

FIG. 15 is a truncated front view of a portion of the fluid container of FIG. 13 shown in cross section.

FIG. 16 is a truncated front view of a portion of a fluid container according to another embodiment shown in cross section.

FIG. 17 is a truncated perspective view of a fluid container according to another embodiment, which features a first port with a dry break and a second port without a dry break.

FIG. 18 is a truncated and exploded perspective view of the fluid container of FIG. 17.

FIG. 19 is a truncated front view of a portion of the fluid container of FIG. 17 shown in cross section.

FIG. 20 is a truncated perspective view of a fluid container according to another embodiment, which features a first port with a dry break and a second port without a dry break.

FIG. 21 is truncated and exploded perspective view of the fluid container of FIG. 20.

FIG. 22 is a truncated front view of a portion of the fluid container of FIG. 20 shown in cross section.

FIG. 23 is a truncated perspective view of a fluid container according to another embodiment, which features a first port with a dry break and a second port without a dry break.

FIG. 24 is a truncated and exploded perspective view of the fluid container of FIG. 23.

FIG. 25 is a truncated front view of a portion of the fluid container of FIG. 23 shown in cross section.

FIG. 26 is a truncated side view of a portion of the fluid container of FIG. 23 shown in cross section.

FIG. 27 is a truncated front view of a fluid container according to another embodiment, which features a first port with a dry break and a second port without a dry break.

FIG. 28 is a truncated and exploded perspective view of the fluid container of FIG. 27.

FIG. 29 is a truncated front view of a portion of the fluid container of FIG. 27 shown in cross section.

FIG. 30 is a truncated side view of a portion of the fluid container of FIG. 27 shown in cross section.

FIG. 31 is a truncated perspective view of a fluid container according to another embodiment, which features a first port with a dry break and a second port with an identical dry break.

FIG. 32 is a truncated and exploded perspective view of the fluid container of FIG. 31.

FIG. 33 is a truncated perspective view of a fluid container according to another embodiment, which features a first port with a dry break and a second port with an identical dry break.

FIG. 34 is a truncated and exploded perspective view of the fluid container of FIG. 33.

FIG. 35 is a truncated front view of a fluid container according to another embodiment shown in cross section.

FIG. 36 is a truncated and magnified front view of a portion of the fluid container of FIG. 35 shown in cross section.

FIG. 37 is a truncated and magnified side view of a portion of the fluid container of FIG. 35 shown in cross section.

FIG. 38 is a truncated front view of a fluid container according to another embodiment shown in cross section.

FIG. 39 is a truncated and magnified front view of a portion of the fluid container of FIG. 38 shown in cross section.

FIG. 40 is a truncated and magnified side view of a portion of the fluid container of FIG. 38 shown in cross section.

FIG. 41 is a truncated perspective view of a fluid container according to another embodiment, which features a first port with a dry break, a second port without a dry break, and a third port.

FIG. 42 is a truncated and exploded perspective view of the fluid container of FIG. 41.

FIG. 43 is a truncated front view of a portion of the fluid container of FIG. 41 shown in cross section.

FIG. 44 is a truncated perspective view of a fluid container according to another embodiment, which features a first port with a dry break, a second port without a dry break, and a third port.

FIG. 45 is a truncated and exploded perspective view of the fluid container of FIG. 44.

FIG. 46 is a truncated front view of a portion of the fluid container of FIG. 44 shown in cross section.

FIG. 47 is a truncated perspective view of a fluid container according to another embodiment, which features a first port with a dry break, a second port without a dry break, and a third port.

FIG. 48 is a truncated and exploded perspective view of the fluid container of FIG. 47.

FIG. 49 is a truncated front view of a portion of the fluid container of FIG. 47 shown in cross section.

FIG. 50 is an exploded perspective view of another fluid container having a first port with a dry break and a second port without a dry break.

FIG. 51 is a truncated front view of a portion of the fluid container of FIG. 50 shown in cross section.

FIG. 52 is an exploded perspective view of another fluid container having a first port with a dry break and a second port without a dry break.

FIG. 53 is a truncated front view of a portion of the fluid container of FIG. 52 shown in cross section.

FIG. 54 is an exploded perspective view of another fluid container having a first port with a dry break and a second port with a dry break.

FIG. 55 is a truncated front view of a portion of the fluid container of FIG. 54 shown in cross section.

FIG. 56 is an exploded perspective view of a fluid container according to another embodiment.

FIG. 57 is a truncated front view of a portion of the fluid container of FIG. 56 shown in cross section.

FIG. 58 is an exploded perspective view of another fluid container having a first port with a dry break and a second port without a dry break.

FIG. 59 is a truncated front view of a portion of the fluid container of FIG. 58 shown in cross section.

FIG. 60 is an exploded perspective view of another fluid container having a first port with a dry break and a second port without a dry break.

FIG. 61 is a truncated front view of a portion of the fluid container of FIG. 60 shown in cross section.

FIG. 62 is an exploded perspective view of another fluid container having a first port with a dry break and a second port with a dry break.

FIG. 63 is a truncated front view of a portion of the fluid container of FIG. 62 shown in cross section.

FIG. 64 is an exploded perspective view of another fluid container having a first port with a dry break and a second port without a dry break.

FIG. 65 is a truncated front view of a portion of the fluid container of FIG. 64 shown in cross section.

FIG. 66 is an exploded perspective view of another fluid container having a first port with a dry break and a second port without a dry break.

FIG. 67 is a truncated front view of a portion of the fluid container of FIG. 66 shown in cross section.

FIG. 68 is an exploded perspective view of another fluid container having a first port with a dry break and a second port with a dry break.

FIG. 69 is a truncated front view of a portion of the fluid container of FIG. 68 shown in cross section.

FIG. 70 is an exploded perspective view of another fluid container having a first port with a dry break and a second port without a dry break.

FIG. 71 is a truncated front view of a portion of the fluid container of FIG. 70 shown in cross section.

FIG. 72 is an exploded perspective view of another fluid container having a first port with a dry break and a second port without a dry break.

FIG. 73 is a truncated front view of a portion of the fluid container of FIG. 72 shown in cross section.

FIG. 74 is an exploded perspective view of another fluid container having a first port with a dry break and a second port with a dry break.

FIG. 75 is a truncated front view of a portion of the fluid container of FIG. 74 shown in cross section.

### DETAILED DESCRIPTION

In the following detailed description, numerous specific details are set forth by way of examples in order to provide a thorough understanding of the relevant teachings. It will be understood that such examples are non-limiting. Numerous variations, changes, substitutions and combinations will occur to those skilled in the art without departing from the scope of the present disclosure and its teachings, and are part of the present disclosure. This includes a substitution of a feature shown in one example with a feature shown in another example, or a combination of a feature shown in one example with a feature shown in another example. All substitutions and combinations are considered part of this written description.

The following description uses various defined terms to describe the physical arrangement and/or orientation of individual parts. The term “longitudinal axis” means or refers to the central axis of an element extending through the long dimension of the element. The terms “axial” and “axially” mean or refer to the direction parallel to the longitudinal axis.

The following description also uses defined terms to describe different types of ports and their respective functions. The term “add port”, as used herein, means a port that permits a fluid to be injected into the fluid container to combine with the contents of the fluid container and form an admixture. The term “set port”, as used herein, means a port that permits the admixture to exit the fluid container and be dispensed to a patient.

The following description further uses terms to describe fluid couplings having certain properties. The term “dry break coupling”, as used herein, means a coupling between two components that prevents liquid or vapor from being released during coupling and decoupling of the two components. The term “dry break”, when used herein without the word “coupling”, means a self-sealing element on a first device that is configured to connect to a self-sealing element on a second device to form a dry break coupling. Thus, a dry break can refer to one half of a dry break coupling, and a dry break coupling can be formed by connecting two dry breaks.

Fluid containers according to the present disclosure feature a dry break that allows hazardous compounds to be safely added into and/or dispensed from the fluid containers. The dry break is configured to couple with a dry break on a closed system transfer device (CSTD). The term “CSTD”, as used herein and as defined by The National Institute for Occupational Safety and Health (NIOSH), means a drug transfer device that mechanically prohibits the transfer of environmental contaminants into the system and the escape of the hazardous drug or vapor concentrations outside the system. The dry break can be integrally formed with the fluid container itself, or integrally formed with an extension portion extending from the fluid container. Alternatively, the dry break can be in the form of an adaptor that is connected to the fluid container itself, or an adaptor that is connected to an extension portion extending from the fluid container.

Fluid containers and CSTDs according to the present disclosure can be provided separately or together as parts of a system. The CSTD can have a dry break that connects to the dry break on the fluid container and a separate connector that connects to a second device or accessory. The second device or accessory can also be provided separately, or as part of the system. For example, the connector on the CSTD can connect to a fluid reservoir, such as a syringe that injects a drug into the fluid container. Alternatively, the connector on the CSTD can be welded to a patient line to administer the drug to a patient.

The dry break on the fluid container can be selectively connected to a first CSTD that transfers a drug to the fluid container, and a second CSTD that transfers the drug from the fluid container to a patient line. For example, the dry break on the fluid container can be connected to a dry break on a first CSTD, which in turn, is connected to a syringe that is pre-filled with a drug. The syringe can be operated to transfer the drug though the first CSTD and into the fluid container. Once the fluid container is filled with the drug, the dry break on the fluid container can be disconnected from the first CSTD and connected to a dry break on a second CSTD that is attached to a patient line. The dry breaks on the fluid container and CSTDs prevent the release of hazardous drug aerosols into the environment, and prevent the entry of contaminants into the fluid container and CSTD, when the dry breaks are connected to and disconnected from each other.

Fluid containers according to the present disclosure can include but are not limited to intravenous (IV) containers and partial additive bags (PABs), as well as containers for other enteral, neuraxial, intrathecal or parenteral applications. The sidewall or sidewalls forming the fluid containers can be formed of a medical film having one or more film layers. The one or more film layers can contain materials that are designed so as to not interact or adversely affect medications stored in the container. Such materials include but are not limited to polyolefins, e.g., polypropylene copolymers, eventually compounded with thermoplastic modifiers.

Fluid containers according to the present disclosure can include a dry break with a cannula for piercing a dry break on another device in order to establish a fluid path. Other fluid containers according to the present disclosure can include a dry break without a cannula. Dry breaks without cannulae can be connected to dry breaks with cannulae on other devices. Fluid containers without cannulae are preferred over containers with cannulae in many instances, particularly when the cannulae contain metal. The presence of metal parts like a cannula in a fluid container will not allow the fluid container to be heated in a microwave oven, which may be desired to treat hypothermia. If the cannula is made of a non-metal or plastic material, then the presence of the cannula is less of a concern. Regardless, it is preferable to minimize the number of components in the fluid container, and more specifically, in the dry break. The cost of producing dry breaks increases as the number of components increases. In addition, the geometries and functionality of small components like plastic cannula can be adversely affected during heat sterilization.

Regardless of the location of the cannula, it is preferable to use “anti-coring” cannula, which are cannula with a closed distal tip and a hole through the side. Anti-coring designs reduce the risk of cutting out portions of septums and other elastomeric components. If sections of septums are cut out and removed by the cannula, the septums will no longer be able to reseal properly, and fluid will be allowed to wet the outer surfaces of the septums and surrounding parts of the connector.

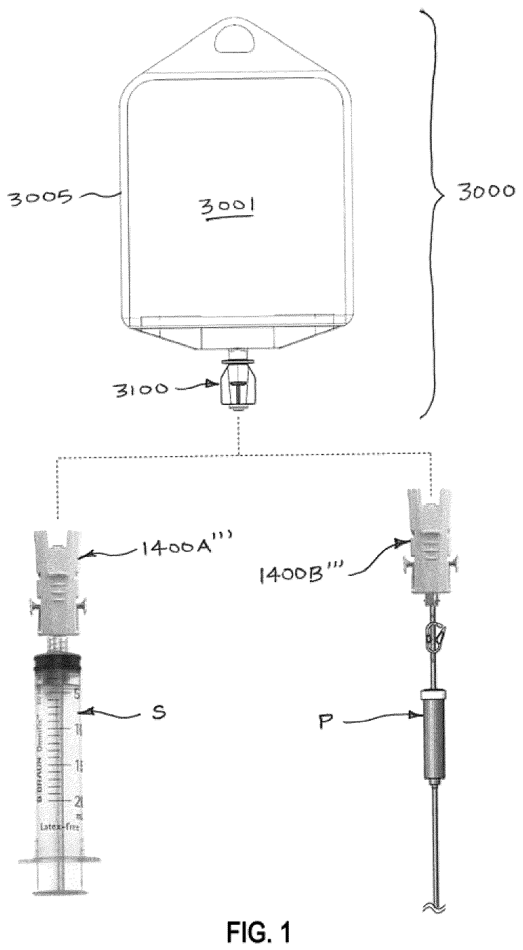

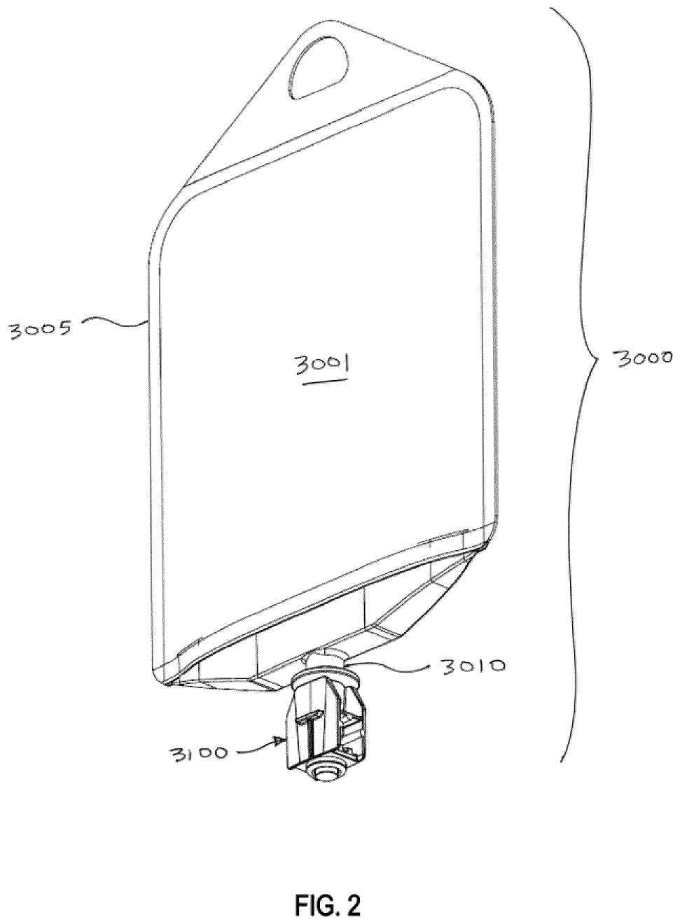

FIGS. 1-4 provide one example of a fluid container 3000 with a dry break according to the present disclosure. Fluid container 3000 has a main body 3005 that encloses an interior space 3001. Main body 3005 has a single access port 3010 that provides access to interior space 3001. Port 3010 is surrounded by a plug 3020 that extends outwardly from main body 3005. Plug 3020 is hollow, forming a conduit 3020a that fluidly connects the exterior of fluid container 3000 with the interior space 3001.

An integrated dry break 3100 is attached over port 3010. Dry break 3100 has parts that are similar to or identical to parts described in International Publication No. WO 2022/232405 A1, the content of which is incorporated by reference herein in its entirety.

Dry break 3100 provides one half of a dry break coupling on the container port. As such, dry break 3100 is configured to connect to a second dry break to form a dry break coupling. Dry break 3100 allows fluid container 3000 to be safely connected to and disconnected from other devices having dry breaks. For example, dry break 3100 allows fluid container 3000 to be safely connected to a first device via a dry break coupling for admixing a medication. After admixing is completed, the dry break coupling allows fluid container 3000 to be safely disconnected from the first device and safely connected to a second device with another dry break for administering the medication. As such, dry break 3100 allows the interior of fluid container 3000 to be accessed multiple times while preventing aerosols in the flexible container 3000 from escaping to the environment during connection or disconnection. This level of safety is not provided by conventional injection ports on bags, because there is no mechanism from sealing the end of the cannula or spike as it is removed from the port. This level of safety is also not provided with Luer activated valves that are used with open-ended Luer or Luer-lock male connectors.

Referring back to FIG. 1, a system is shown that features fluid container 3000 and two reservoirs that can be connected to the fluid container at different stages of use. In the present example, dry break 3100 is selectively attachable to a first CSTD 1400A′″ and a second CSTD 1400B′″. First CSTD 1400A′″ and second CSTD 1400B′″ can be identical CSTDs or different CSTDs. First CSTD 1400A′″ is attached to a syringe S for injecting a drug into fluid container 3000. Second CSTD 1400B′″ is bonded to a closed IV administration set (or patient set) P configured to administer the medication to a patient.

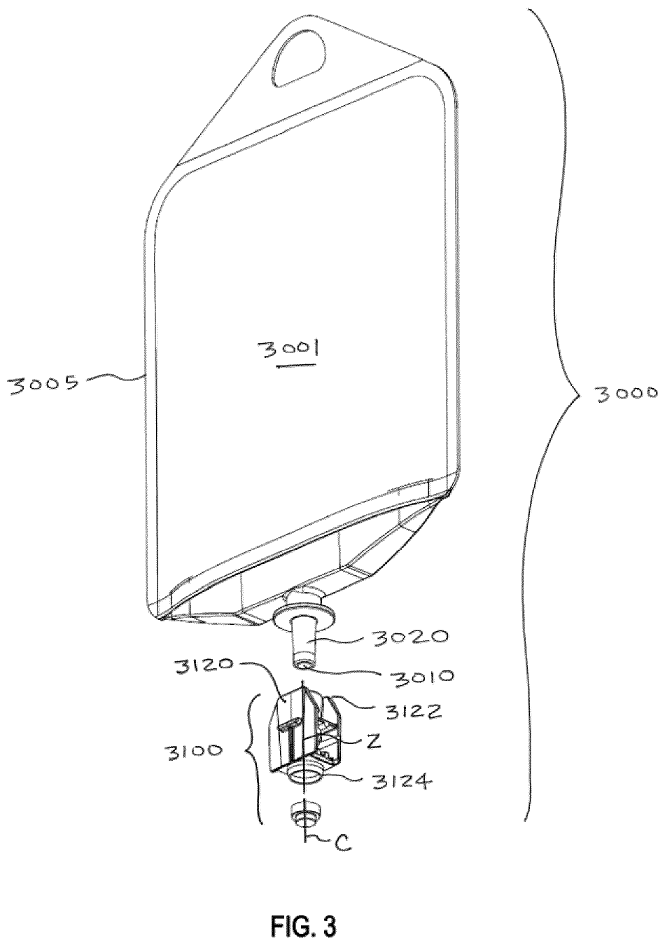

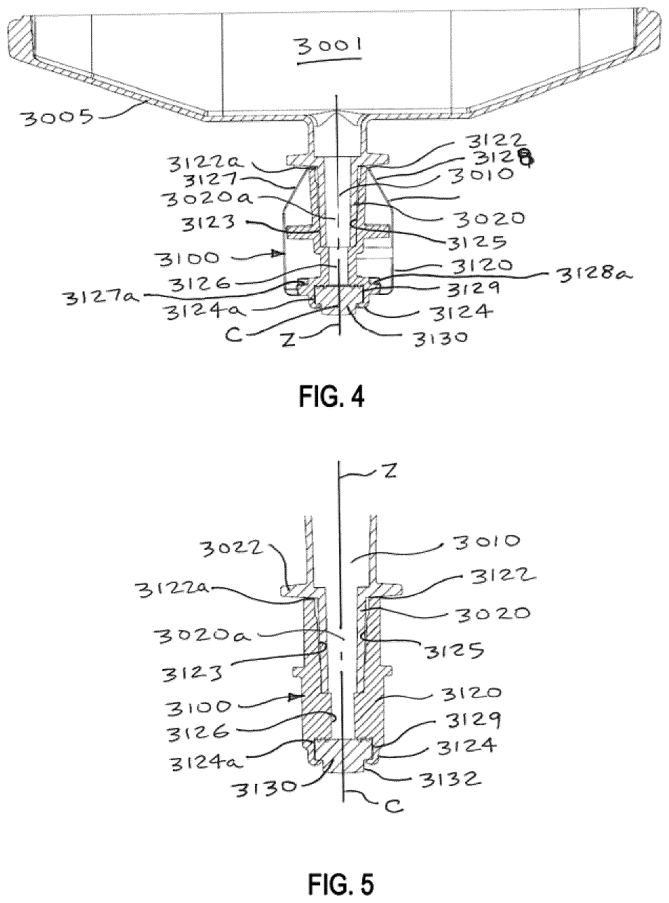

Referring to FIGS. 3-5, dry break 3100 has an adaptor body 3120 with a first end 3122 and a second end 3124. Adaptor body 3120 defines a longitudinal axis Z that passes through the center of the first end 3122 and second end 3124. Longitudinal axis Z is an axis of symmetry in two planes. As such, the geometry of adaptor body 3120 is symmetrical with respect to longitudinal axis Z in the view shown in FIG. 4 and in the view shown in FIG. 5, which is rotated 90 degrees from the view in FIG. 4.

First end 3122 of adaptor body 3120 has a first opening 3122a and second end 3124 has a second opening 3124a. First opening 3122a and second opening 3124a are connected by a passage 3126 that extends along longitudinal axis Z. First end 3122 has a socket 3123 configured to receive plug 3020 that extends from fluid container 3000. The outer geometry of plug 3020 conforms to a frustum of a cone. The sidewall of plug 3020 includes a flange 3022 extending around the circumference of the plug. Socket 3123 has a cone-shaped or tapered interior wall 3125 that conforms to the exterior shape of plug 3020. Plug 3020 is permanently attached to wall 3125 by any suitable connection means, including but not limited to a bonding compound or welding.

Second end 3124 of adaptor body 3120 defines a chamber or seat 3129. Seat 3129 contains a septum 3130 that seals second opening 3124a. Septum 3130 is made of elastomeric material that permits a cannula to penetrate through the septum. The elastomeric material automatically closes or “reseals” after the septum is moved past the tip of the cannula. A portion of septum 3130 extends axially from second opening 3124a, forming a projection 3132. Projection 3132 is configured to abut with and be deformed by septums on first and second CSTDs 1400A′″ and 1400B′″, or other devices, to form a dry break coupling in the manner described in previous examples.

Septum 3130 has a circular disc-shaped geometry having a center axis C. Center axis C is coaxial with longitudinal axis Z. The symmetrical geometry of adaptor body 3120 is configured to engage with mating surfaces on a second adaptor, such as first CSTD 1400A′″ or second CSTD 1400B′″, so that the septum on the second device is centered relative to the longitudinal axis Z and septum 3130. This ensures that the cannula in the second device is aligned with longitudinal axes C and Z and enters passage 3126 correctly.

Adaptor body 3120 has a first side 3127 with a first ledge 3127a and a second side 3128 opposite the first side with a second ledge 3128a, as shown in FIG. 4. Ledges 3127a and 3128a are configured to be engaged by carriers in the second device, such as the ends of the flexible clips described in previous examples, to lock the dry break 3100 to the carrier in a sealed engagement.

Fluid containers according to the present disclosure can have a single port with a dry break or multiple ports. If the container has multiple ports, at least one of the ports has a dry break. If there is only one port, the port functions as a set port. If there are two or more ports, at least one port can function as an add port, and at least one other port can function as a “set port”. Alternatively, one or more of the ports can serve as both the add port and the set port. In the example in FIGS. 1-5, port 3010 functions as both the add port and the set port.

Fluid containers according to the present disclosure can have a first port with a dry break and a second port without a dry break. This combination of two different ports on a single container provides a versatile design that accommodates different types of admixtures and treatments. For example, if a pharmacy needs to admix a hazardous drug, then they can use the first port with the dry break as the add port, and inject the drug into the container through the dry break adaptor. If a caregiver needs to administer the hazardous drug, then they can also use the first port with the dry break as the set port. If the drug is non-hazardous, then the pharmacy can use the second port without the dry break as the add port, and inject the drug into the container though second port. If the caregiver needs to administer the non-hazardous drug, then they can also use the second port without the dry break as the set port. As such, the fluid container is pre-configured to be filled with a hazardous drug and/or a non-hazardous drug, and pre-configured to administer a hazardous drug and/or non-hazardous drug. This versatility allows pharmacies to use the fluid container in multiple ways and reduce the number of fluid containers that must be stocked at the pharmacy. The built-in dry break is also beneficial because it can connect directly to a syringe adaptor with a dry break. This avoids having to stock a separate bag spike connector, connect the bag spike adaptor to the fluid container, and subsequently connect a 20) syringe adaptor to the bag spike adaptor to safely fill the container.

The next section describes examples of containers having a first port with a dry break and a second port without a dry break. The second port without a dry break can include, but is not limited to, a needle-free port, e.g., a Luer Lock or stopper-based port, or a spike port adapter. Features that correspond to features of fluid container 3000 are labeled with the same reference numbers increased by multiples of one thousand. Some features that are identical or equivalent to previously described features will not be described for brevity, with the understanding that the same descriptions apply.

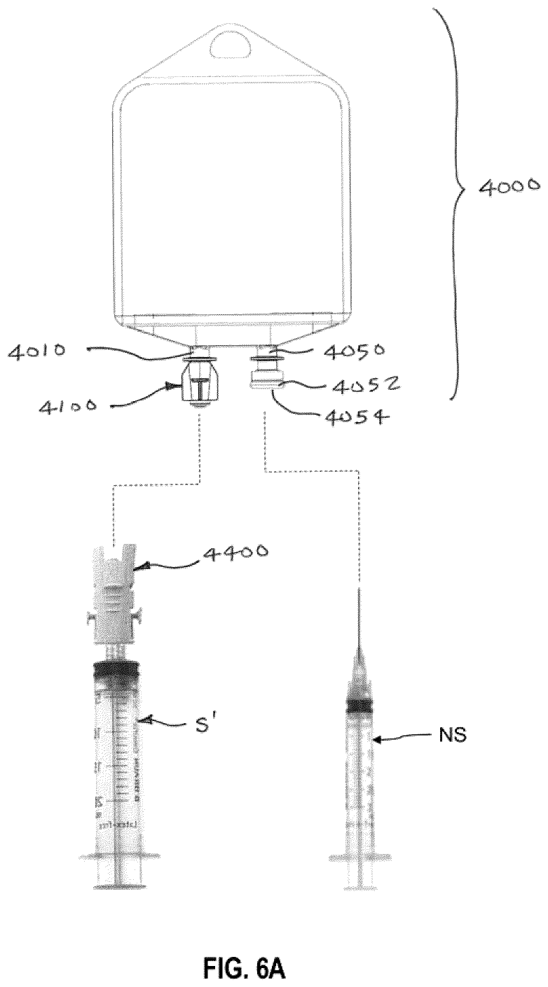

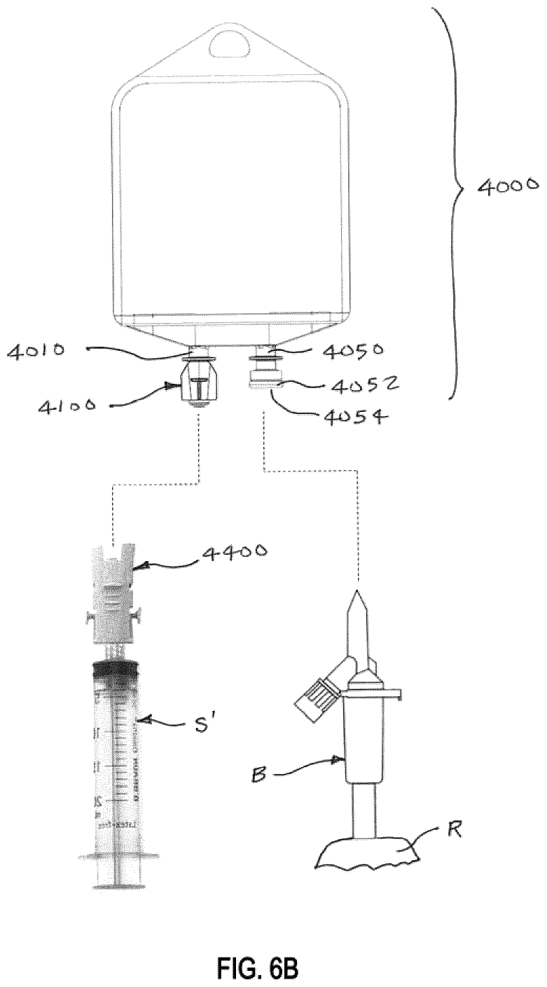

Referring to FIG. 6A, a system is shown that features another fluid container 4000 and two reservoirs that can be connected to the fluid container, depending on the type of drug being admixed. Unlike the previous system that was described, fluid container 4000 has two ports: a first port 4010 and a second port 4050. First port 4010 is connected to an integrated dry break 4100 that is identical to dry break 3100. Second port 4050 is a non-dry break, featuring a port opening 4052 that contains a stopper 4054.

First port 4010 and dry break 4100 are attachable to a syringe adaptor 4400 with a dry break, like CSTD 1400A′″ in FIG. 1. Syringe adaptor 4400 is connected to a syringe S′ that contains a drug ingredient to be injected into fluid container 4000. This connection to first port 4010 can be used if the drug to be admixed is hazardous, in which case the dry break coupling between dry break 4100 and syringe adaptor 4400 prevents the release of harmful aerosols when the first port is connected to or disconnected from the syringe adaptor.

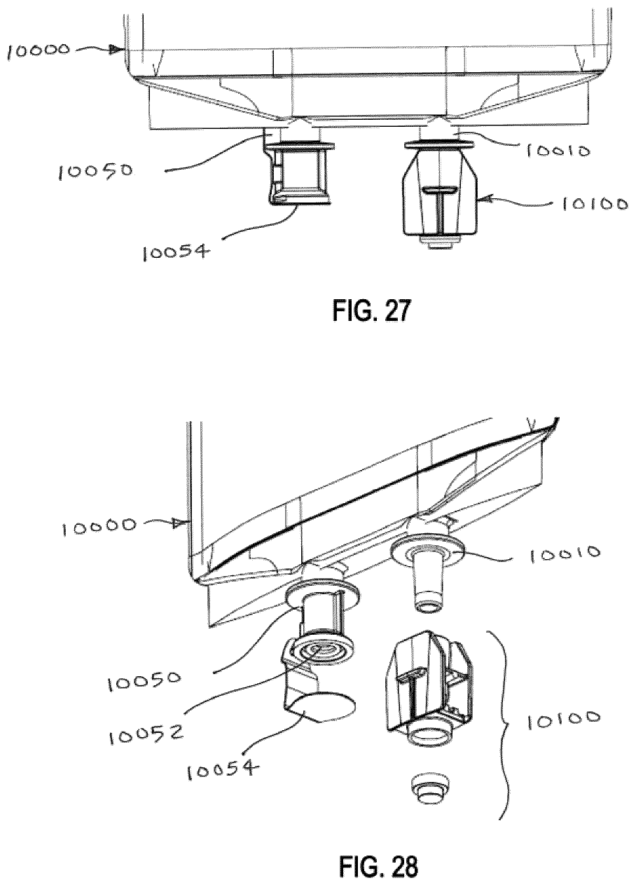

Second port 4050 is configured for use when the drug to be admixed is non-hazardous. Port opening 4052 and stopper 4054 are configured to be connected with different devices. FIG. 6A shows a needle syringe NS configured to pierce stopper 4054 to inject a non-hazardous ingredient into fluid container 4000. FIG. 6B shows a bag spike adaptor B configured to penetrate stopper 4050 and transfer a non-hazardous ingredient from a reservoir R into fluid container 4000. These are just two possible uses for second port 4050. Therefore, it will be appreciated that other uses are possible for second port 4050. In addition, there are other port configurations that can be used for the non-dry break. For example, the second port could also take the form of a spike port, such as spike port 10050 shown and described in connection with FIG. 27. Such a spike port could be used with bag spike adaptor B in FIG. 6B to transfer a non-hazardous ingredient from the reservoir R into fluid container 4000. Alternatively, the spike port could be connected to an IV spike to deliver medication to a patient.

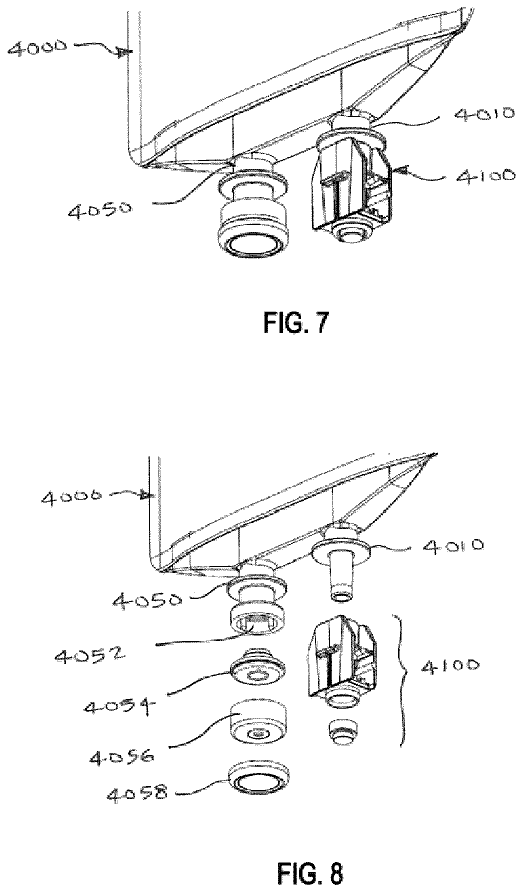

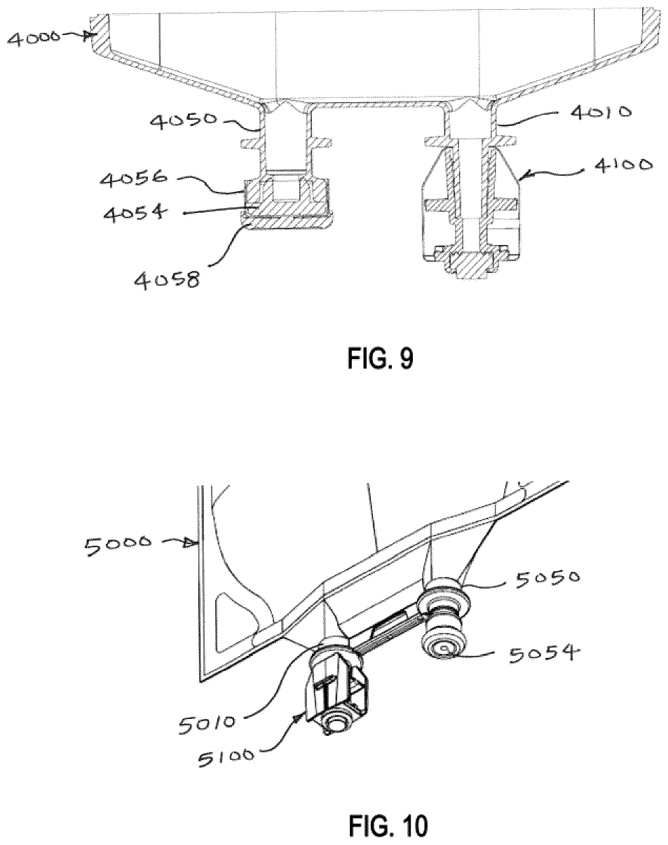

FIGS. 7-9 show components of fluid container 4000 in more detail. First port 4010 is connected to dry break 4100 in the same manner that the corresponding port 3010 and dry break 3100 are connected on fluid container 3000. Port opening 4052 in second port 4050 contains the stopper 4054, a cap 4056 and a protective cover 4058. First port 4010 can be used as the add port and as the set port if the drug is hazardous, and second port 4050 can be used as the add port if the drug is non-hazardous.

Ports and dry breaks according to the present disclosure have fluid tight closures. These closures include, but are not limited to, stoppers and septums formed of elastomeric materials. Some closure materials contain components that are leachable or extractable if they are permitted to directly contact certain liquids over an extended period of time. Leaching or extraction of such components can contaminate the contents of a fluid container and pose a risk to a patient if the contamination is not detected. Therefore, fluid containers, ports and dry breaks according to the present disclosure can feature temporary membranes that physically seal off and separate the closures from the interior volumes of the fluid containers. The membranes are intended to remain closed or sealed until the fluid containers are used, at which time the membranes can be broken, punctured, or removed to permit fluid to contact the closures. The term “membrane”, as used herein, means any physical structure that fluidly separates one space or void from another space or void, and that is capable of being partially or completely broken, punctured, removed, or otherwise compromised to allow the flow of fluid between the two spaces or voids. Examples of membranes include but are not limited to barriers and webs of material that are integrally formed with ports, tubes or other parts of a fluid container.

The membrane can be located at any location in a port, or at any location in a dry break. Alternatively, the membrane can be located anywhere in a tube that connects a dry break or a port to the main body of a fluid container. The membrane can be formed of the same material as the material of the wall surrounding the membrane.

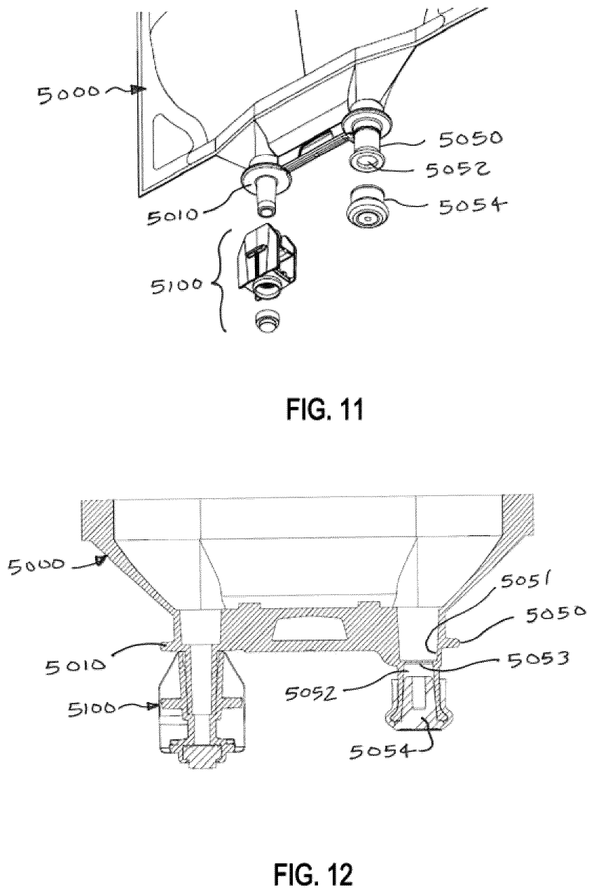

FIGS. 10-12 show one example of a fluid container 5000 with a membrane 5053. Fluid container 5000 has a first port 5010 and a second port 5050. First port 5010 is connected to an integrated dry break 5100 that is also identical to dry break 3100. Second port 5050 has a port opening 5052 that contains the membrane 5053 and a stopper 5054. Membrane 5053 is configured to be punctured or separated from the inner wall 5051 of second port 5050 by a spike or other fluid connector that does not have a dry break. In this example, first port 5010 can be used as the add port and set port if the drug is hazardous. Second port 5050 can be used as the add port if the drug is non-hazardous.

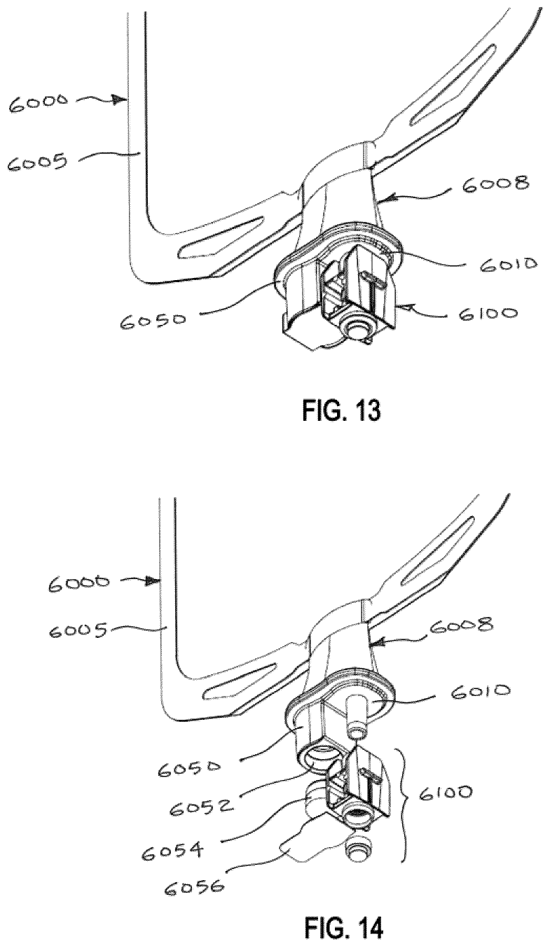

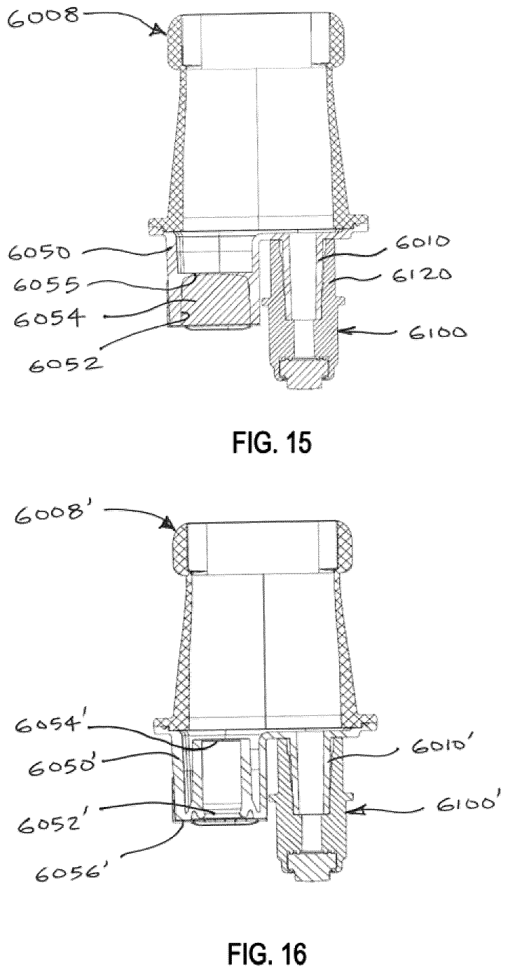

FIGS. 13-15 show another fluid container 6000 with a port assembly 6008 attached to main body 6005. Port assembly 6008 includes a first port 6010 and a second port 6050. First port 6010 is connected to an integrated dry break 6100 that is identical to dry break 3100. Second port 6050 has a port opening 6052 that contains a stopper 6054 and breakable membrane 6055 located inside the port opening. A peelable cover 6056 seals the port opening, stopper 6054 and membrane 6055 prior to use. First port 6010 can be used as the add port and set port if the drug is hazardous. Second port 6050 can be used as the add port if the drug is non-hazardous.

FIG. 16 shows an alternate port assembly 6008′ that can be attached to fluid container 6000, or any other fluid container described herein. Port assembly 6008′ includes a first port 6010′ identical to first port 6010, with an integrated dry break 6100′ that is identical to dry break 3100. Second port 6050′ is similar to second port 6050, with a port opening 6052′ and peelable cover 6056′. Port opening 6052′ contains a thin membrane 6054′ but does not include a stopper. First port 6010′ can be used as the add port and set port if the drug is hazardous. Second port 6050′ can be used as the set port if the drug is non-hazardous.

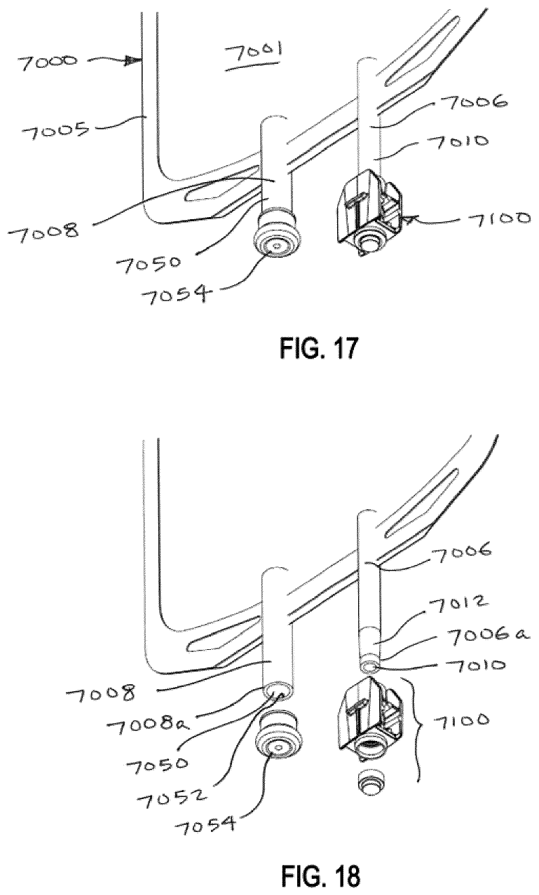

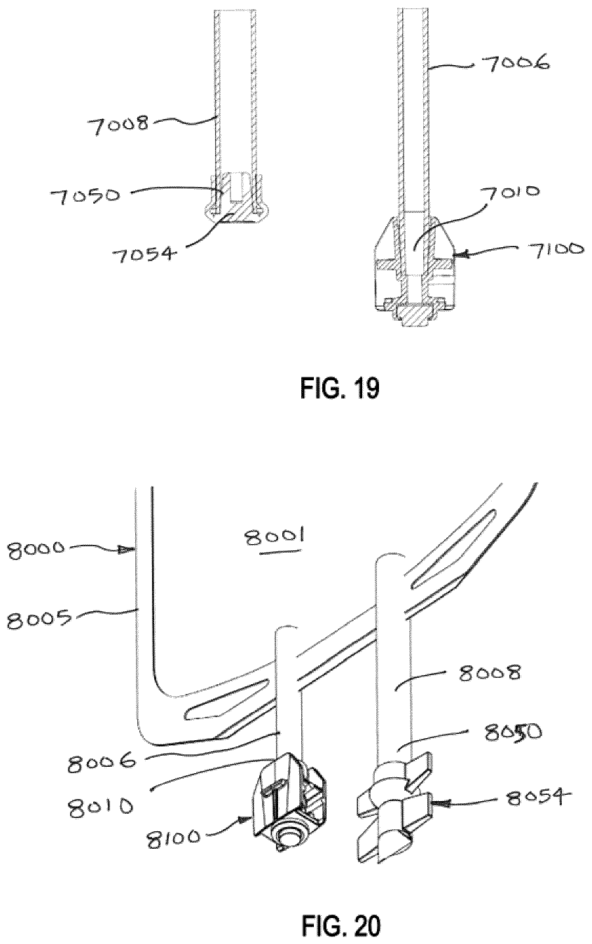

FIGS. 17-19 show another fluid container 7000 with a first port 7010 and a second port 7050 similar to those in FIGS. 104-106. Fluid container 7000 has a main body 7005 with a first tube 7006 and a second tube 7008. First tube 7006 and second tube 7008 are each connected to an interior volume 7001 inside main body 7005. The outermost end 7006a of first tube 7006 defines the first port 7010, and the outermost end 7008a of second tube 7008 defines the second port 7050. First port 7010 has a tapered cone-shaped geometry 7012 that connects to an integrated dry break 7100 identical to dry break 3100. Second port 7050 has a port opening 7052 that contains a stopper 7054. First port 7010 can be used as the add port and set port if the drug is hazardous. Second port 7050 can be used as the add port if the drug is non-hazardous.

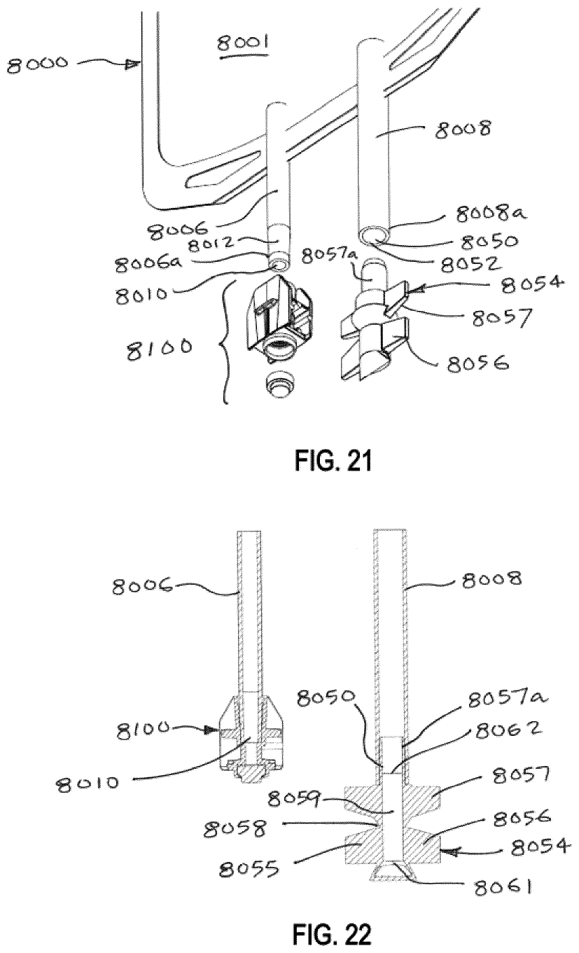

FIGS. 20-22 show another fluid container 8000 with a first port 8010 and a second port 8050. Fluid container 8000 has a main body 8005 with a first tube 8006 and a second tube 8008. First tube 8006 and second tube 8008 are each connected to an interior volume 8001 inside main body 8005. The outermost end 8006a of first tube 8006 has a first port 8010, and the outermost end 8008a of second tube 8008 has a second port 8050. First port 8010 has a tapered cone-shaped geometry 8012 that connects to an integrated dry break 8100 identical to dry break 3100.

Second port 8050 has a port opening 8052 connected to a spike port adaptor 8054. Spike port adaptor 8054 comprises a tubular body 8055 with a first section 8056, a second section 8057 and a breakable or frangible section 8058 that connects the first section with the second section. A fluid passage 8059 extends through the first section 8056 and second section 8057. Second section 8057 has a plug portion 8057a configured to be inserted into second tube 8008 in a sealed manner as shown. Plug portion 8057a forms a fluid connection with the interior of second tube 8008 and interior volume 8001 of fluid container 8000. First section 8056 contains a membrane 8061 that seals fluid passage 8059 so that the fluid passage remains sterile and protected from outside contaminants. Second section 8057 contains another membrane 8062 that seals fluid passage 8059 and second tube 8008 so that the contents of fluid container 8000 does not exit the second tube. Membrane 8062 is configured to be breakable from the inner wall of plug portion 8057a in response to advancement of a spike, such as a spike connected to a patient set. The allows a spike to penetrate through membrane 8062 and fluidly connect with second tube 8008 and interior volume 8001 of fluid container 8000.

In use, fluid container 8000 is filled with a diluent or other contents and delivered to the pharmacy. First tube 8006 is sealed by dry break 8100, and second tube 8008 is sealed by spike port adaptor 8054. Dry break 8100 is attached to first tube 8006 by a chemical bond or weld. Spike port adaptor 8054 is attached to second tube 8008 also by a chemical bond or weld. The pharmacist injects a drug through dry break 8100 and creates the admixture within the interior volume 8001 of fluid container 8000. The fluid container 8000 is then delivered to a caregiver responsible for administering the drug to a patient. To administer the admixture, the caregiver breaks off the first section 8056 of the spike port adaptor to expose passage 8059. The caregiver then inserts a spike attached to a patient set into passage 8059 and advances the spike through membrane 8062 and into fluid connection with interior volume 8001. Spike port adaptor 8054 forms a fluid seal with the spike and provides a conduit that fluidly connects with the patient set to administer the medication to the patient. Thus, in this particular example, first port 8010 is the add port and second port 8050 is the set port.

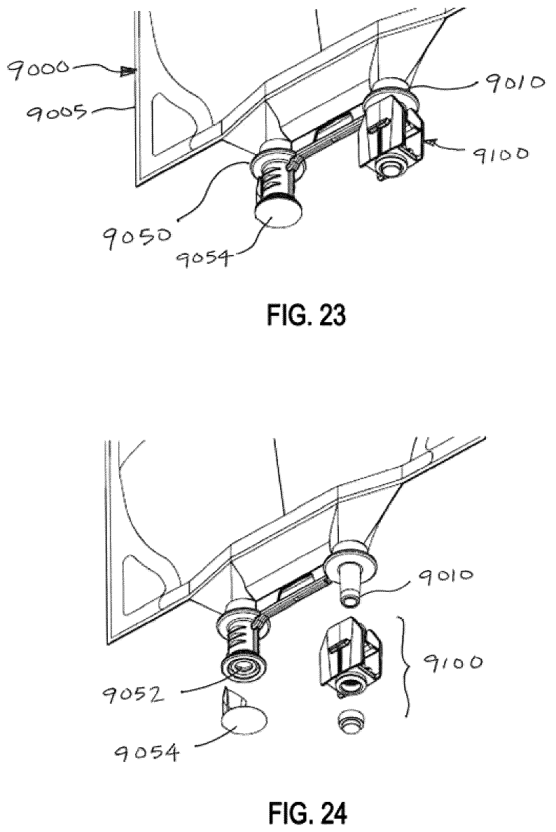

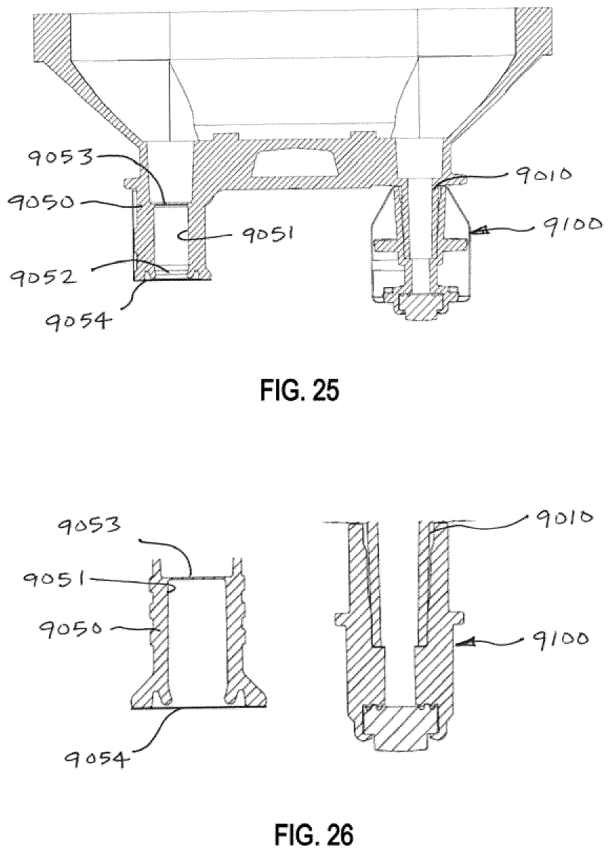

FIGS. 23-26 show another fluid container 9000 with a main body 9005, a first port 9010 and a second port 9050. First port 9010 is connected to an integrated dry break 9100 that is also identical to dry break 3100. Second port 9050 has a port opening 9052 that contains a membrane 9053 and peelable cover 9054. Membrane 9053 is configured to be punctured or separated from an inner wall 9051 of second port 9050 by a spike. In this example, first port 9010 can be used as the add port and set port if the drug is hazardous. Second port 9050 can be used as a set port if the drug is hazardous or non-hazardous.

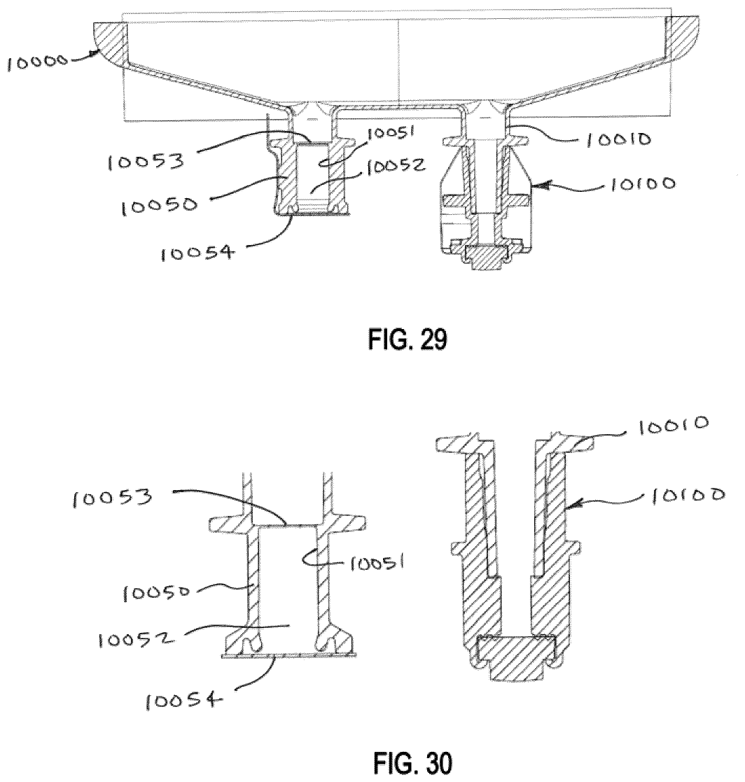

FIGS. 27-30 show another fluid container 10000 with a first port 10010 and a second port 10050. First port 10010 is connected to an integrated dry break 10100 that is also identical to dry break 3100. Second port 10050 has a port opening 10052 that contains a membrane 10053 and peelable cover 10054. Membrane 10053 is configured to be punctured or separated from an inner wall 10051 of second port 10050 by a spike. In this example, first port 10010 can be used as the add port and set port if the drug is hazardous. Second port 10050 can also be used as a set port if the drug is hazardous or non-hazardous.

The next section describes examples of containers with multiple ports, where a first port is provided with a dry break and a second port is also provided with a dry break. Features that correspond to features of fluid container 3000 are labeled with the same reference numbers increased by multiples of one thousand. Some features that are identical or equivalent to previously described features will not be described for brevity, with the understanding that the same descriptions apply.

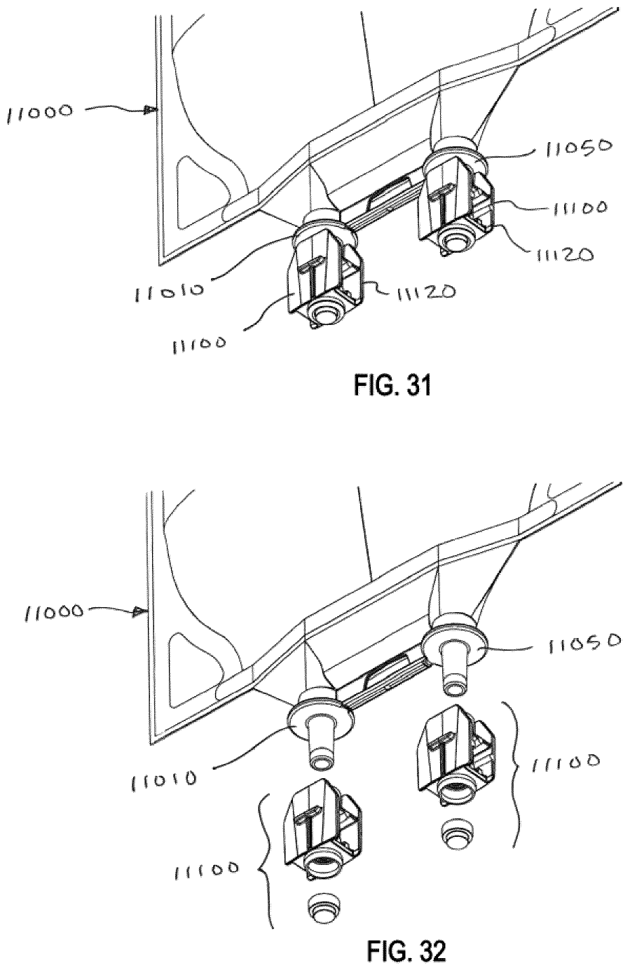

FIGS. 31 and 32 show a fluid container 11000 with a first port 11010 and a second port 11050. First port 11010 and second port 11050 are each connected to an integrated dry break 11100. Dry breaks 11100 are identical to dry break 3100, have the same adaptor body 11120, and can function as a set port and/or an add port for hazardous drugs. In an alternate embodiment, first port 11010 can be connected to a dry break 11100, and second port 11050 can be connected to a different dry break. For example, second port 11050 can be connected to a dry break with an adaptor body shaped and/or sized differently from adaptor body 11120. This combination of two dry breaks with different configurations can be used to control or limit what connections can be made with each port.

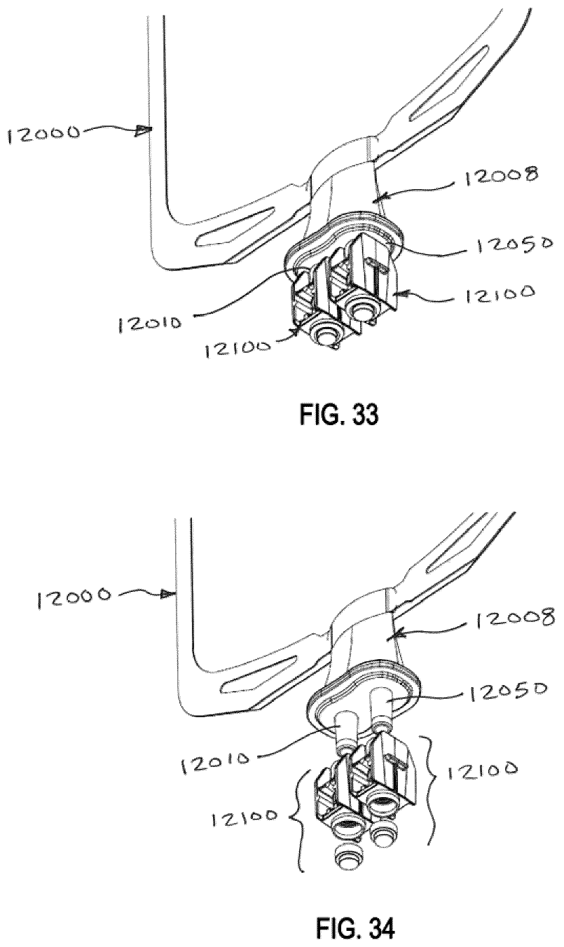

FIGS. 33 and 34 show another fluid container 12000 with a port assembly 12008 attached to main body 12005. Port assembly 12008 includes a first port 12010 and a second port 12050. First port 12010 and second port 12050 are each connected to an integrated dry break 12100. Each dry break 12100 is identical to dry break 3100, and can function as a set port and/or an add port for hazardous drugs. Dry breaks 12100 are rotated ninety degrees relative to the orientations of dry breaks 11100 in the previous example, so that the longer sides of the adaptor bodies face one another. This arrangement allows first port 12010 and second port 12050 to be positioned closer together and reduce the width of port assembly 12008.

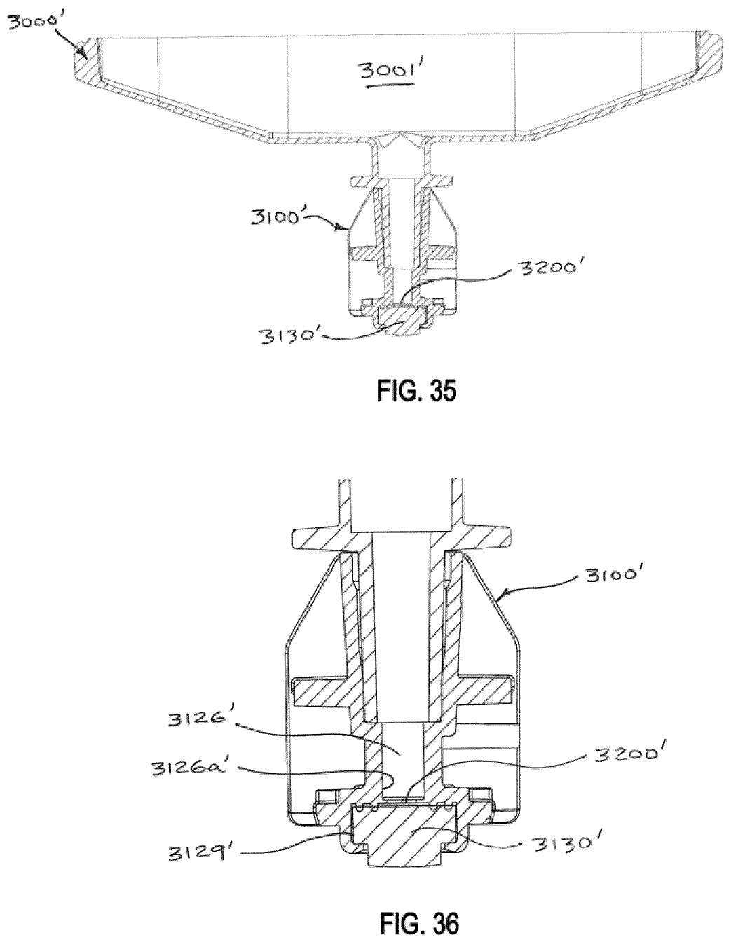

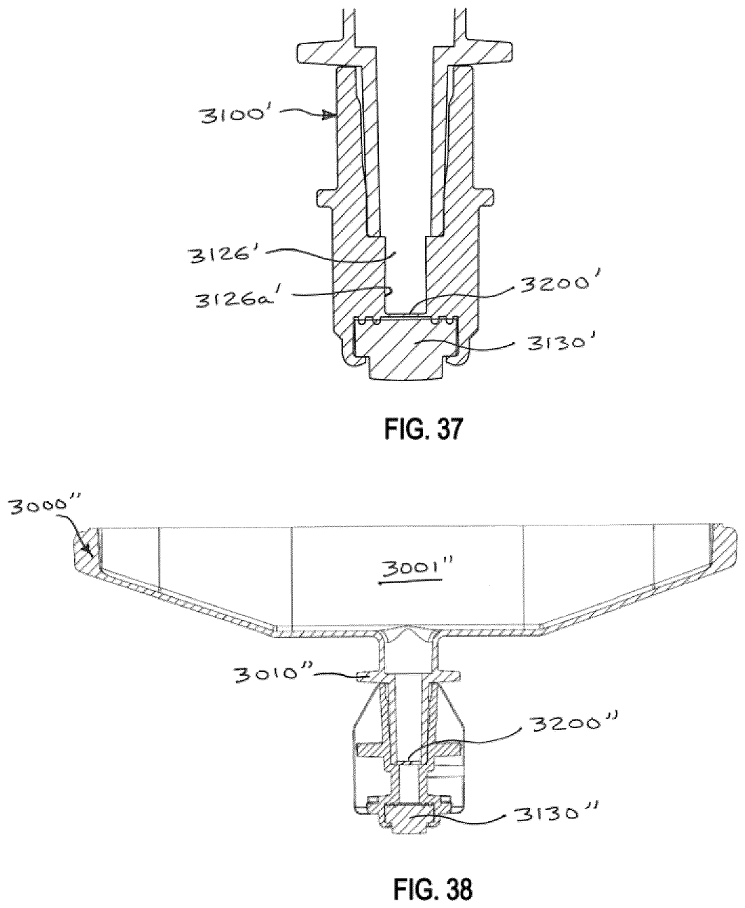

FIGS. 35-37 show a fluid container 3000′ with a membrane 3200′ located in the body of a dry break 3100′. Fluid container 3000′ is identical to fluid container 3000, with the exception of the membrane 3200′. Features of fluid container 3000′ that correspond to features of fluid container 3000 are labeled with the same reference numbers accompanied by a prime symbol (′). Some features that are identical to features of fluid container 3000 will not be described for brevity, with the understanding that the same descriptions apply.

Membrane 3200′ is attached to an inner wall 3126a′ of passage 3126′ where the passage and chamber 3129′ intersect. Passage 3126′ is completely sealed and closed off by membrane 3200′. In this arrangement, membrane 3200′ physically seals off and separates the septum 3130′ from the interior volume 3001′ of fluid container 3000′ until the fluid container is used. Membrane 3200′ is a thin strip or web of material that is the same material that forms inner wall 3126′. The thickness of membrane 3200′ is small enough to permit a cannula, spike or other fluid transfer implement to either puncture through a central portion of the membrane, or separate the membrane from the inner wall.

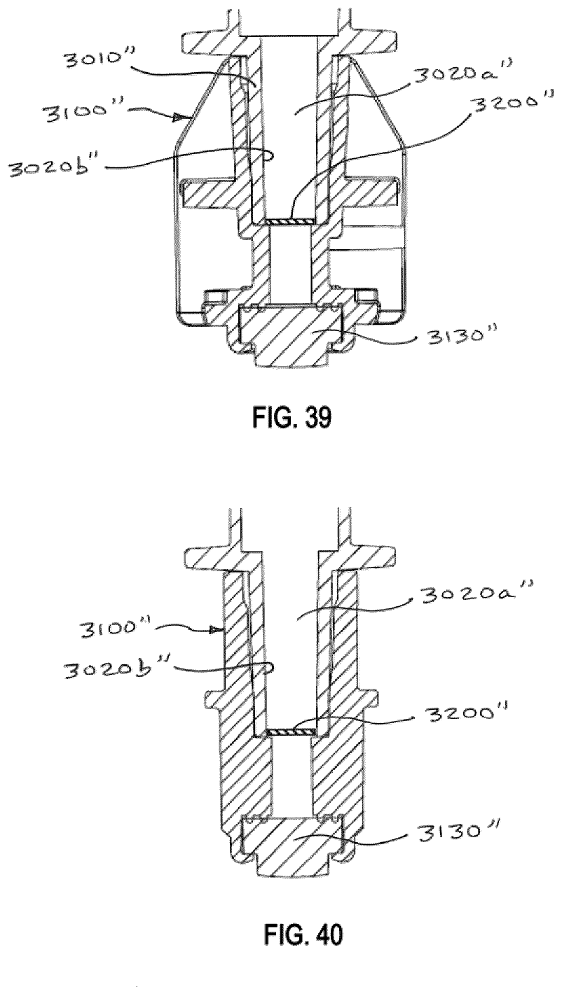

FIGS. 38-40 show a fluid container 3000″ with another example of a membrane 3200″ located in the port 3010″. Fluid container 3000″ is identical to fluid container 3000, with the exception of the membrane 3200″. Features of fluid container 3000″ that correspond to features of fluid container 3000 are labeled with the same reference numbers accompanied by two prime symbols (″). Some features that are identical to features of fluid container 3000 will not be described for brevity, with the understanding that the same descriptions apply.

Membrane 3200″ is attached to an inner wall 3020b″ of conduit 3020a″ at the end of plug 3020″. Conduit 3020″ is completely sealed and closed off by membrane 3200″. In this arrangement, membrane 3200″ physically seals off and separates the interior volume 3001″ of fluid container 3000″ from the interior of dry break 3100″, and consequently from septum 3130″, until the fluid container is used. Membrane 3200″ is a thin strip or web of material that is the same material that forms inner wall 3020b″ of conduit 3020a″. As in the previous membrane example, the thickness of membrane 3200″ is small enough to permit a cannula, spike or other fluid transfer implement to either puncture through a central portion of the membrane, or separate the membrane from the inner wall. The axial distance between membrane 3200″ and septum 3130″ is greater than the distance between the membrane and septum in the previous example, and thus requires a longer fluid transfer implement to puncture or break the membrane.

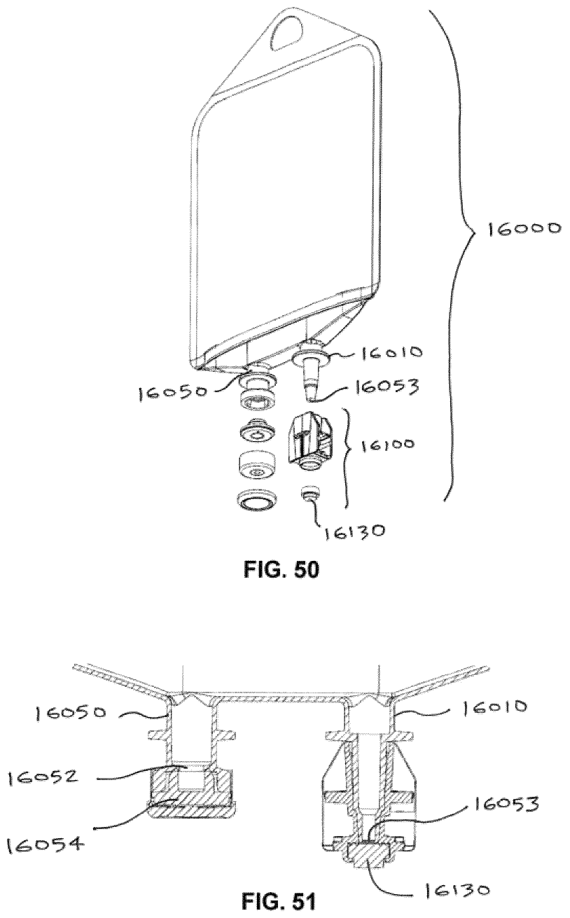

FIGS. 50-75 show additional container embodiments with membranes located in dry breaks. For brevity, some features in FIGS. 50-75 that are identical or equivalent to previously described features will not be described, with the understanding that the same descriptions apply.

FIGS. 50 and 51 show a fluid container 16000 with a first port 16010 and a second port 16050. First port 16010 is connected to an integrated dry break 16100 featuring a septum 16130. First port 16010 also has a membrane 16053 at a distal end that is positioned adjacent to the septum. Membrane 16053 can be immediately or directly adjacent to septum 16130 so that the membrane and septum are in direct contact. Alternatively, membrane 16053 can be located in proximity to but separated from septum 16130 by a small gap. Both arrangements are contemplated in the present embodiment. Moreover, both arrangements are contemplated in any embodiment described herein that features a membrane and septum in the same port. Second port 16050 has a port opening 16052 that contains a stopper 16054.

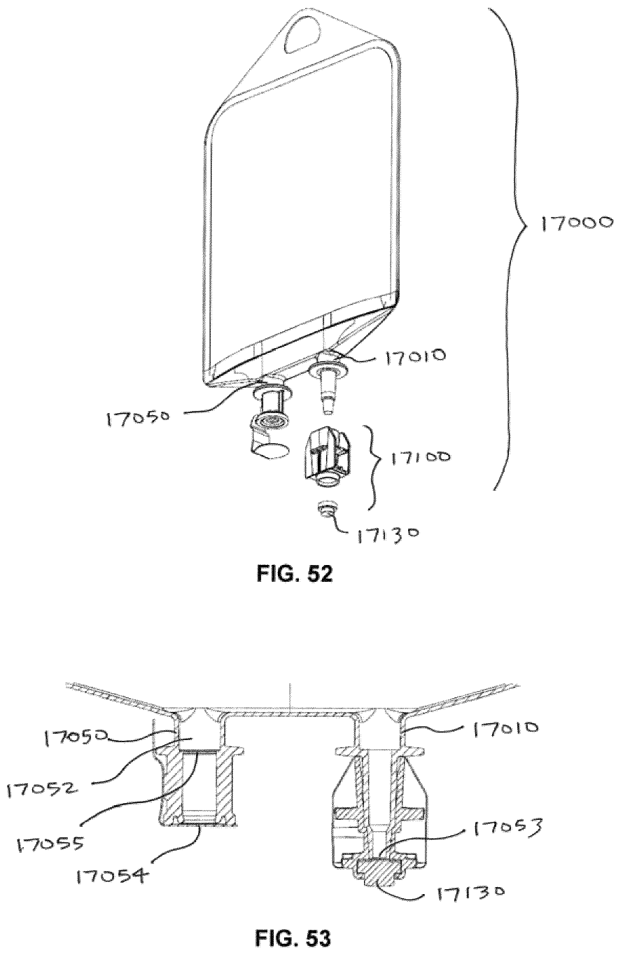

FIGS. 52 and 53 show a fluid container 17000 with a first port 17010 and a second port 17050. First port 17010 is connected to an integrated dry break 17100 featuring a septum 17130. First port 17010 also has a membrane 17053 positioned adjacent to the septum. Second port 17050 has a port opening 17052 that contains a membrane 17055 and a peelable cover 17054.

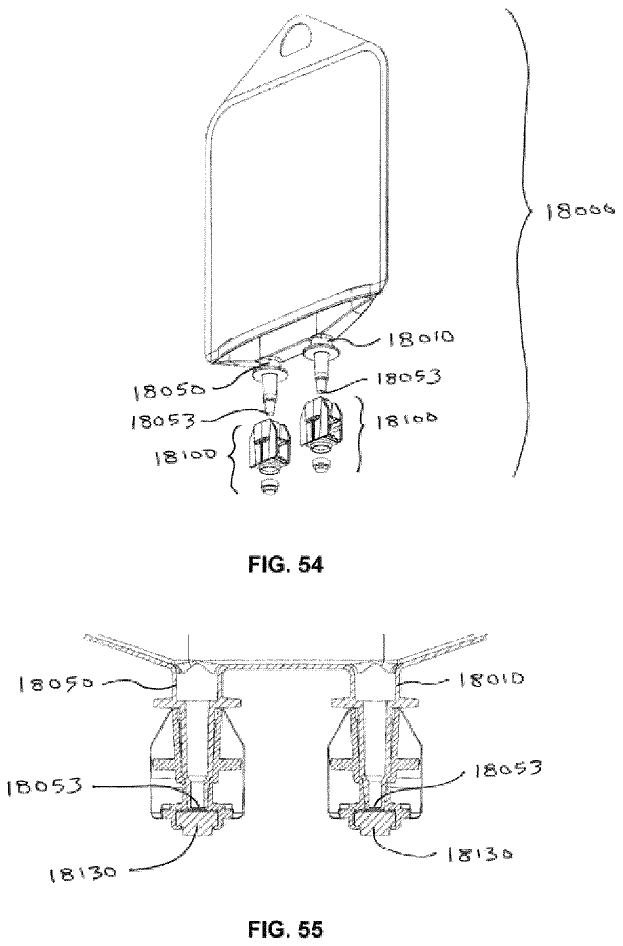

FIGS. 54 and 55 show a fluid container 18000 with a first port 18010 and a second port 18050. First port 18010 and second port 18050 are each connected to an integrated dry break 18100. Each dry break 18100 features a septum 18130. First port 18010 and second port 18050 each have a membrane 18053 positioned adjacent to septum 18130.

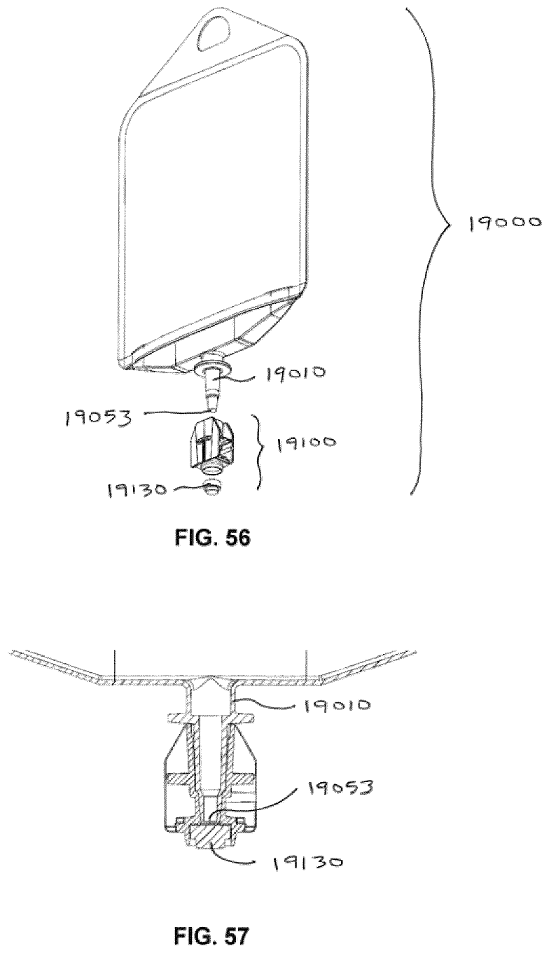

FIGS. 56 and 57 show a fluid container 19000 with only a single port 19010. Port 19010 is connected to an integrated dry break 19100 that features a septum 19130. Port 19010 has a membrane 19053 positioned adjacent to septum 19130.

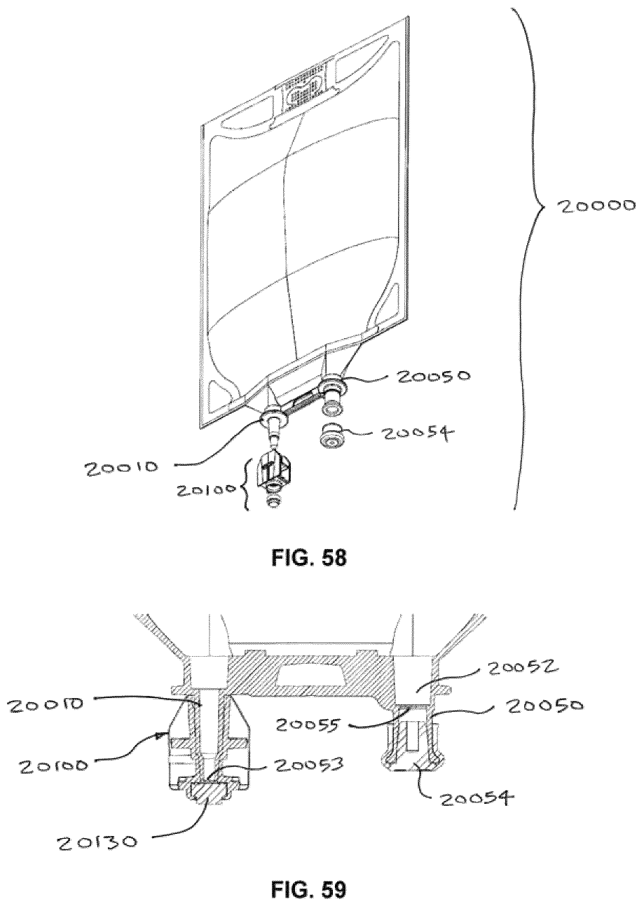

FIGS. 58 and 59 show a fluid container 20000 with a first port 20010 and a second port 20050. First port 20010 is connected to an integrated dry break 20100 featuring a septum 20130. First port 20010 also has a membrane 20053 positioned adjacent to septum 20130. Second port 20050 has a port opening 20052 that contains a membrane 20055 and a stopper 20054.

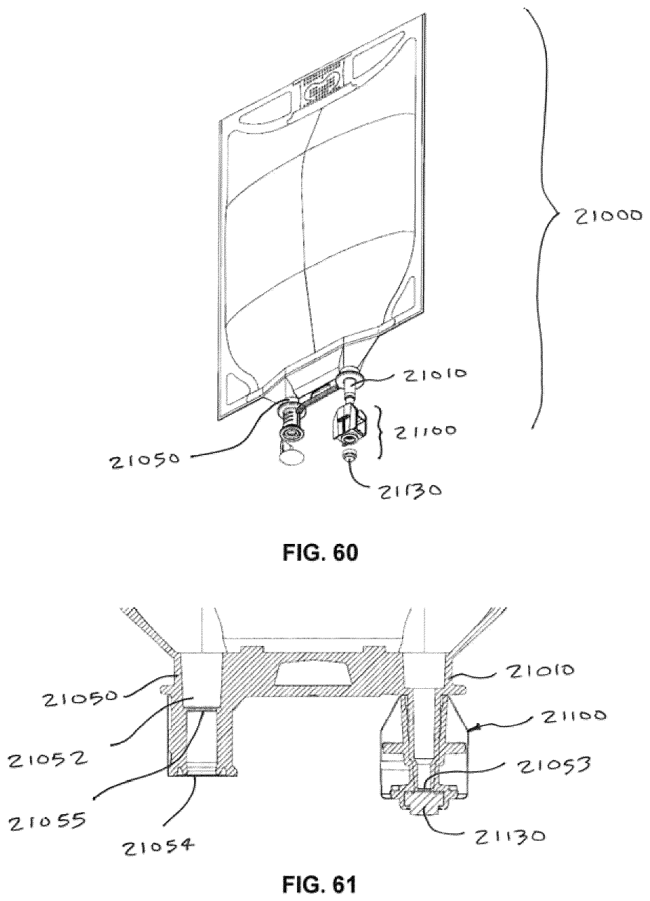

FIGS. 60 and 61 show a fluid container 21000 with a first port 21010 and a second port 21050. First port 21010 is connected to an integrated dry break 21100 featuring a septum 21130. First port 21010 also has a membrane 21053 positioned adjacent to septum 21130. Second port 21050 has a port opening 21052 that contains a membrane 21055 and a peelable cover 21054.

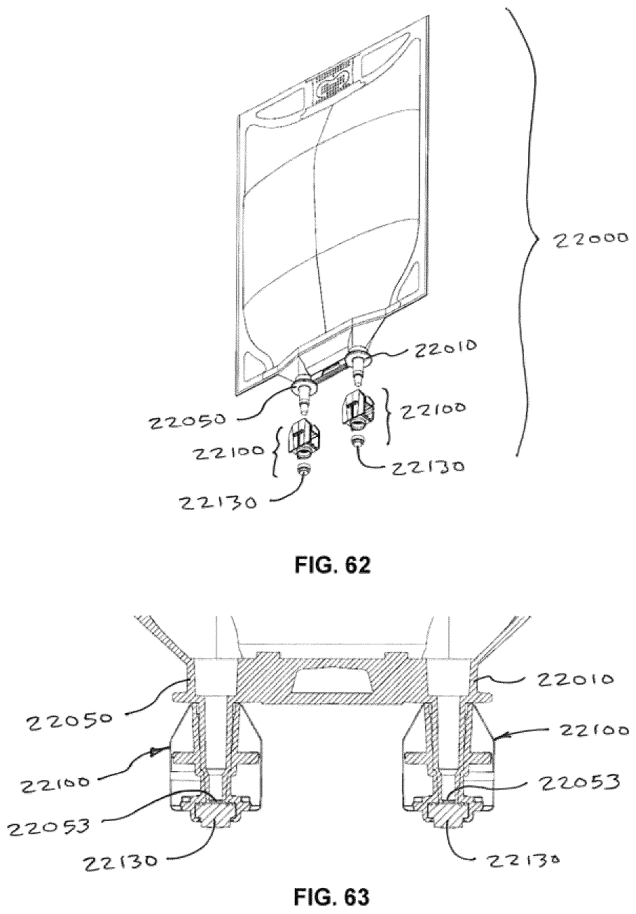

FIGS. 62 and 63 show a fluid container 22000 similar to fluid container 18000 in FIGS. 54 and 55, but with a different structure between the ports and main body of the fluid container. Fluid container 22000 has a first port 22010 and a second port 22050 that are each connected to an integrated dry break 22100. Each dry break 22100 features a septum 22130. First port 22010 and second port 22050 each have a membrane 22053 positioned adjacent to a septum 22130 in the associated dry break 22100.

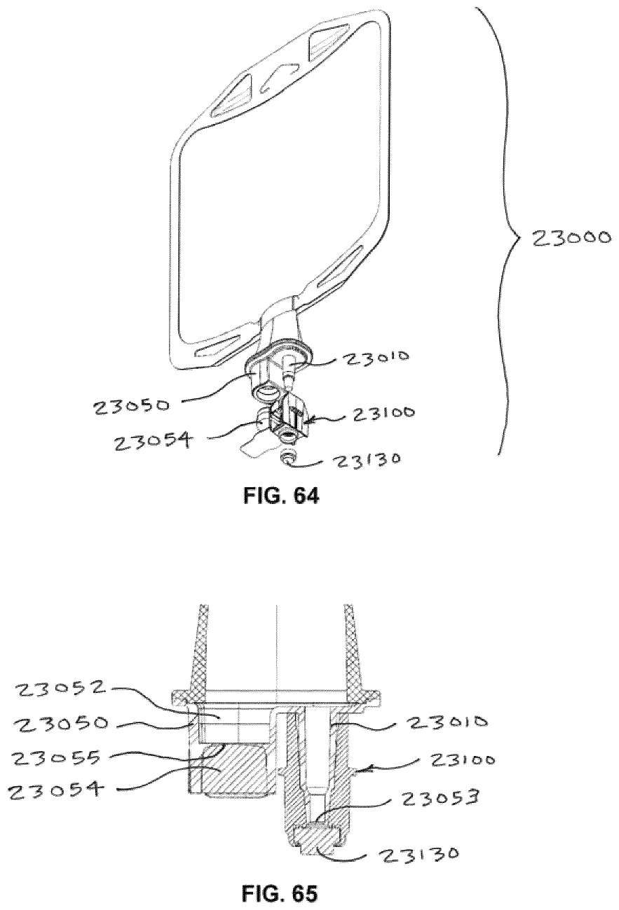

FIGS. 64 and 65 show a fluid container 23000 with a first port 23010 and a second port 23050. First port 23010 is connected to an integrated dry break 23100 featuring a septum 23130. First port 23010 also has a membrane 23053 adjacent to septum 23130. Second port 23050 has a port opening 23052 that contains a membrane 23055 and a stopper 23054.

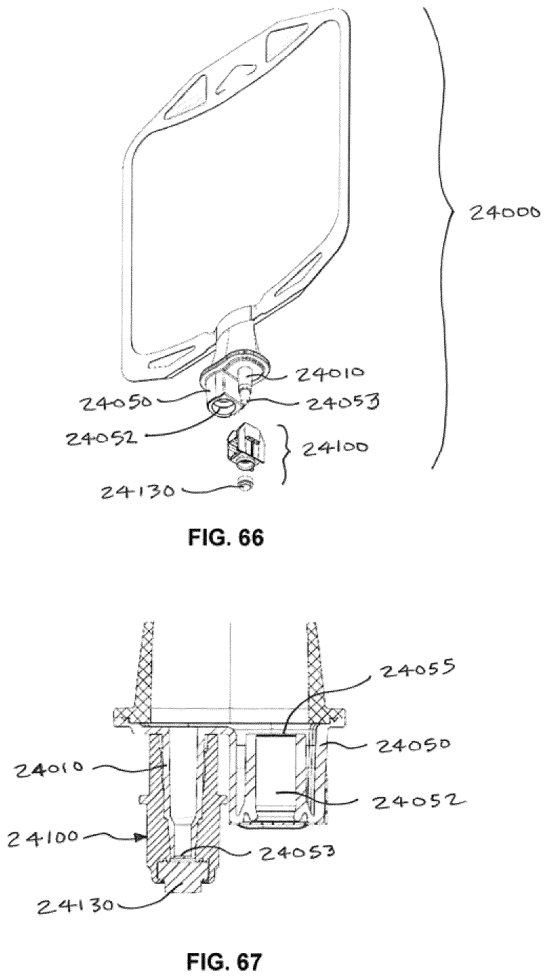

FIGS. 66 and 67 show a fluid container 24000 with a first port 24010 and a second port 24050. First port 24010 is connected to an integrated dry break 24100 featuring a septum 24130. First port also has a membrane 24053 adjacent to septum 24130. Second port 24050 has a port opening 24052 that contains a membrane 24055.

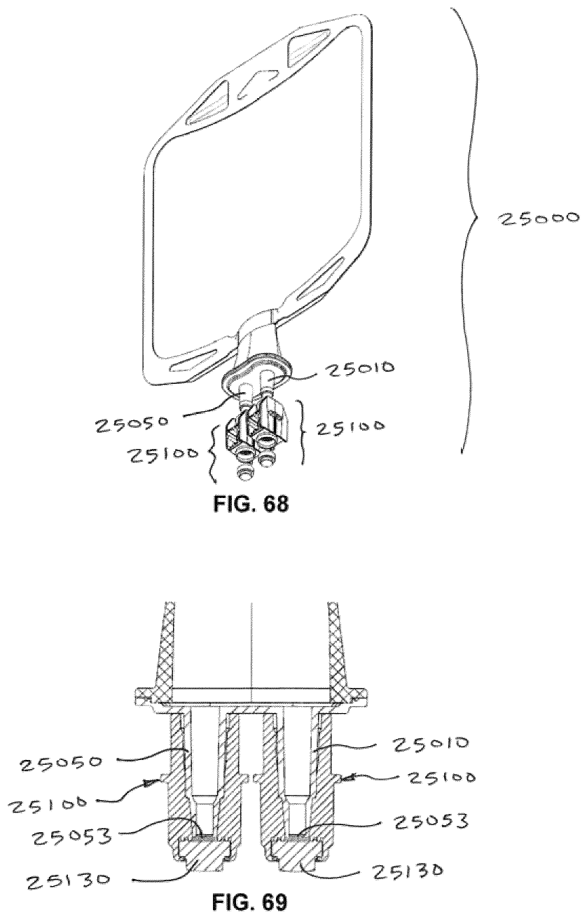

FIGS. 68 and 69 show a fluid container 25000 with a first port 25010 and a second port 25050. First port 25010 and second port 25050 are each connected to an integrated dry break 25100 featuring a septum 25130. In addition, first port 25010 and second port 25050 each have a membrane 25053 that is adjacent to a septum 25130 in the associated dry break 25100.

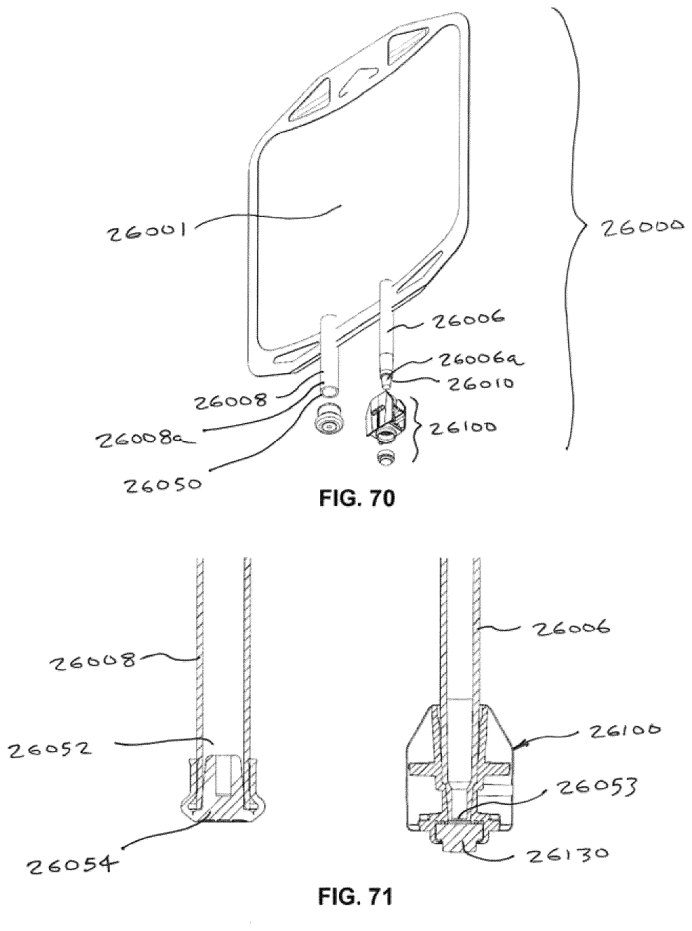

FIGS. 70 and 71 show a fluid container 26000 with a first tube 26006 and a second tube 26008. First tube 26006 and second tube 26008 are each connected to an interior volume 26001 of fluid container 26000. The outermost end 26006a of first tube 26006 defines a first port 26010, and the outermost end 26008a of second tube 26008 defines a second port 26050. First port 26010 is connected to an integrated dry break 26100 featuring a septum 26130. First port 26010 also has a membrane 26053 adjacent to septum 26130. Second port 26050 has a port opening 26052 that contains a stopper 26054.

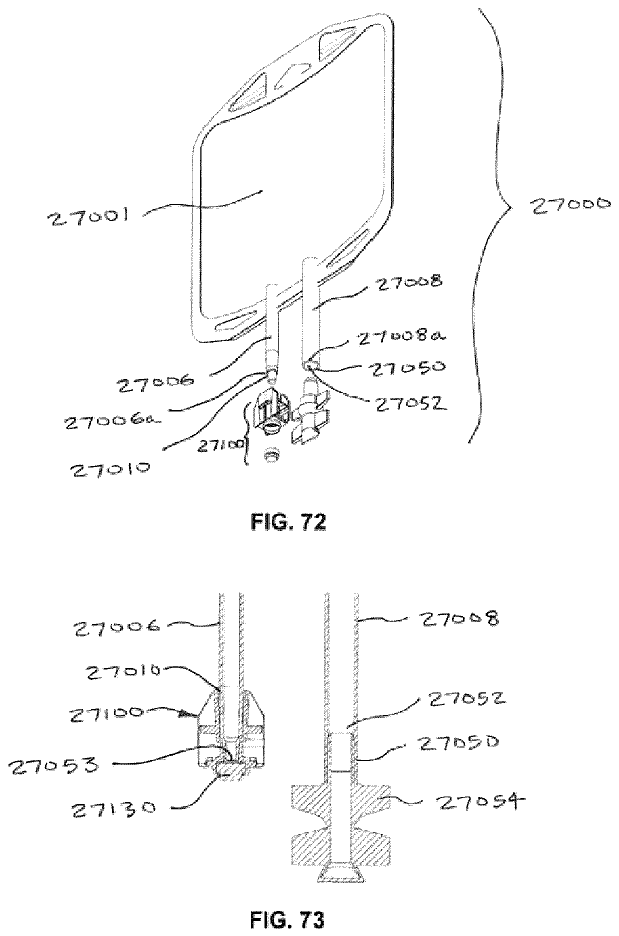

FIGS. 72 and 73 show a fluid container 27000 with a first tube 27006 and a second tube 27008. First tube 27006 and second tube 27008 are each connected to an interior volume 27001 of fluid container 27000. The outermost end 27006a of first tube 27006 defines a first port 27010, and the outermost end 27008a of second tube 27008 defines a second port 27050. First port 27010 is connected to an integrated dry break 27100 featuring a septum 27130. First port 27010 also has a membrane 27053 adjacent to septum 27130. Second port 27050 has a port opening 27052 that contains a spike port adaptor 27054.

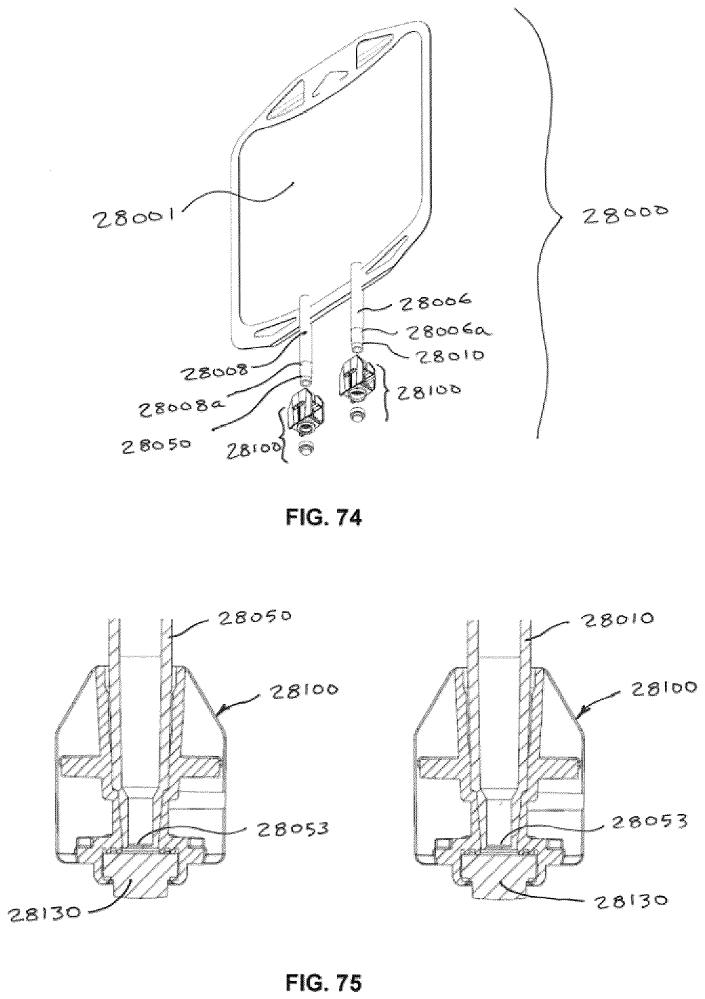

FIGS. 74 and 75 show a fluid container 28000 with a first tube 28006 and a second tube 28008. First tube 28006 and second tube 28008 are each connected to an interior volume 28001 of fluid container 28000. The outermost end 28006a of first tube 28006 defines a first port 28010, and the outermost end 28008a of second tube 28008 defines a second port 28050. First port 28010 and second port 28050 are each connected to an integrated dry break 28100 featuring a septum 28130. First port 28010 and second port 28050 each have a membrane 28053 adjacent to a septum 28130 in the associated dry break 28100.

It will be appreciated that any of the foregoing membranes and their arrangements can be incorporated into any of the fluid containers shown, described, or contemplated within the scope of this disclosure.

The next section describes examples of containers with multiple ports, where a first port is provided with a dry break and a second port is provided with either a needle-free adaptor or stopper adaptor port. Some features that correspond to features of fluid container 3000 are labeled with the same reference numbers increased by multiples of one thousand. In addition, some features that are identical or equivalent to previously described features will not be described for brevity, with the understanding that the same descriptions apply.

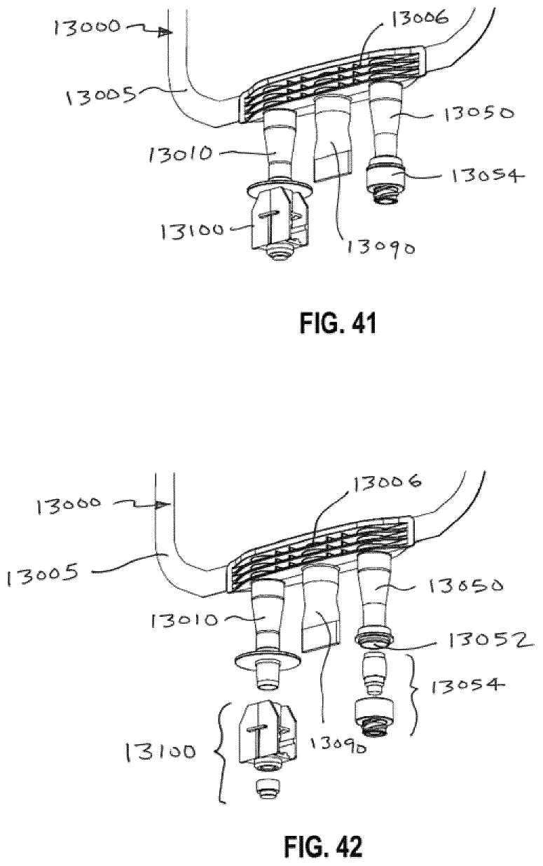

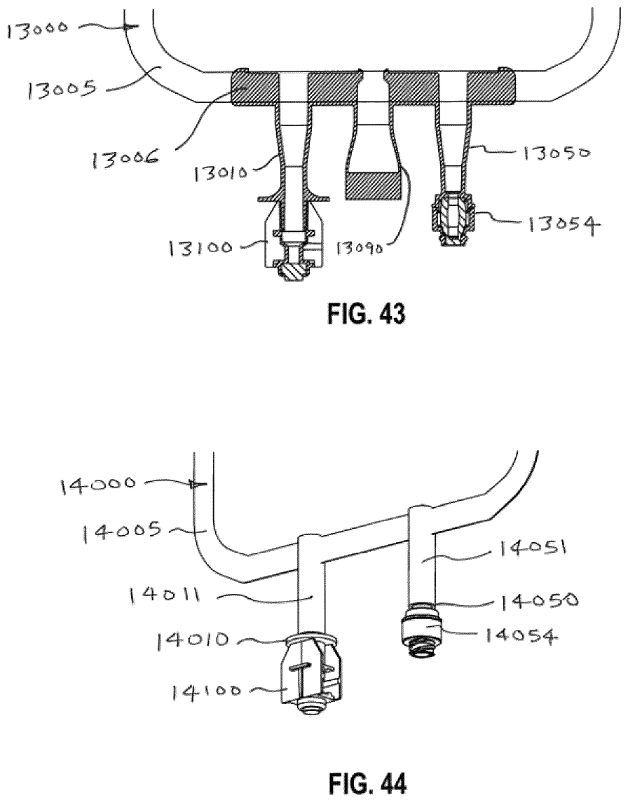

FIGS. 41-43 shows a fluid container 13000 with a first port 13010, a second port 13050 and a third port 13090. First port 13010 is connected to an integrated dry break 13100 that is also identical to dry break 3100. Second port 13050 has an opening 13052 that fluidly connects with a needle-free adaptor 13054, which can be a female Luer-Lock-adaptor or a female NRFit-adaptor. Third port 13090 is a filling tube that is used for filling fluid container 13000 when the filling tube is in an open state. After fluid container 13000 is filled, the filling tube is heated and squeezed or pinched until the port is closed and sealed as shown. Needle-free adaptor 13054 is configured to connect to a male mating connector, such as a male connector on a syringe. The mating needle-free connectors can comply for example with ISO 80369-7 (“Connectors for intravascular application”, in particular Luer and Luer-Lock connectors) or ISO 80369-8 (“Connectors for neuraxial application”). In the present example, first port 13010 and second port 13050 are rigidly connected to a rigid base 13006 on fluid container body 13005. First port 13010 can be used as the add port and set port if the drug is hazardous. Second port 13050 can be used as an alternative add port.

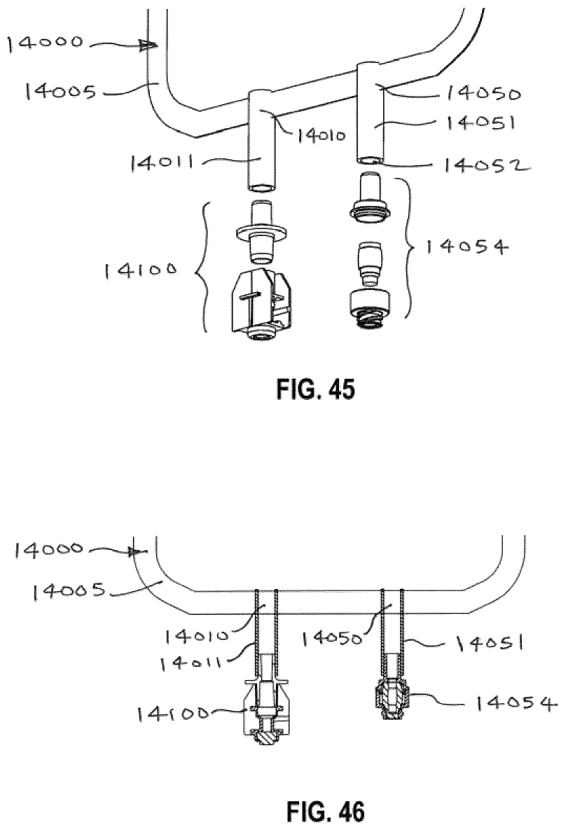

FIGS. 44-46 show another fluid container 14000 with a first port 14010 and a second port 14050. First port 14010 is connected to an integrated dry break 14100 that is also identical to dry break 3100. Second port 14050 has an opening 14052 that fluidly connects with a needle-free adaptor 14054, which can be a female Luer-Lock-adaptor or a female NRFit-adaptor. Needle-free adaptor 14054 is configured to be connected to a male mating connector, such as a male connector on a syringe. The mating needle-free connectors can comply for example with ISO 80369-7 (“Connectors for intravascular application”, in particular Luer and Luer-Lock connectors) or ISO 80369-8 (“Connectors for neuraxial application”). In the present example, first port 14010 is connected to a first flexible tube 14011 and second port 14050 is connected to a second flexible tube 14051. First and second flexible tubes 14011 and 14051 are individually attached to fluid container body 14005. First port 14010 can be used as the add port and set port if the drug is hazardous. Second port 14050 can be used as an alternative add port.

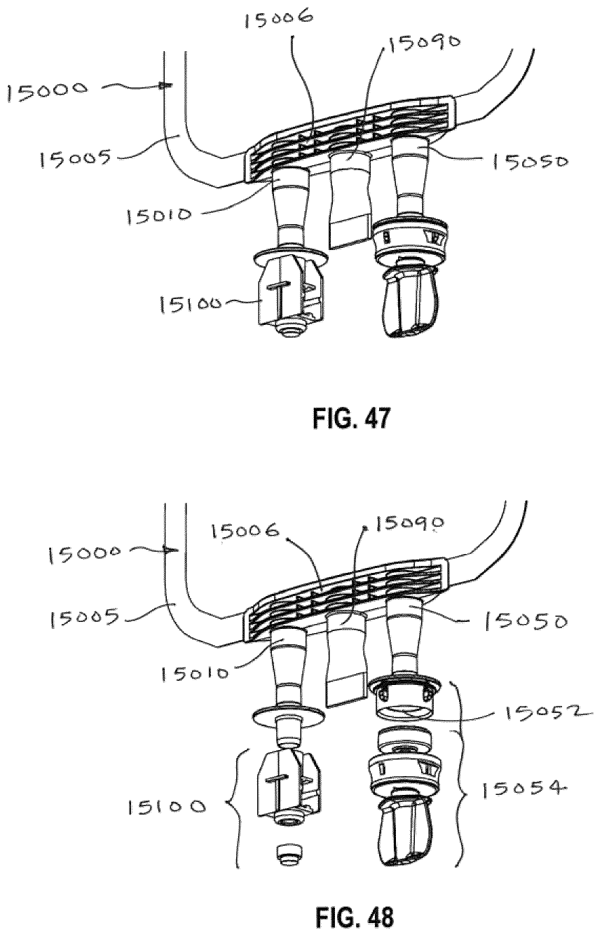

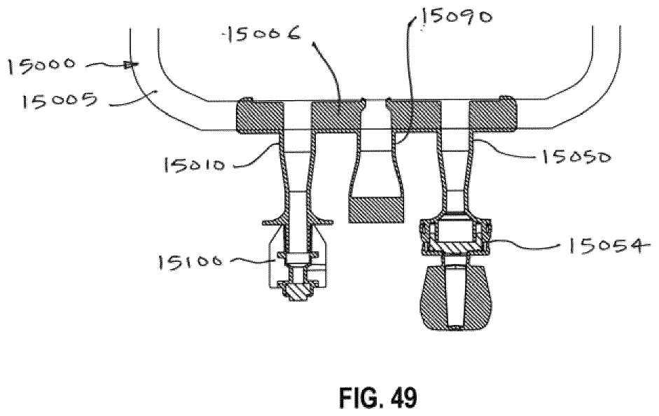

FIGS. 47-49 show another fluid container 15000 with a first port 15010, a second port 15050, and a third port 15090. First port 15010 is connected to an integrated dry break 15100 that is also identical to dry break 3100. Second port 15050 has an opening 15052 that fluidly connects to a stopper-based access adaptor 15054. Third port 15090 is a filling tube that is used for filling fluid container 15000 when the filling tube is in an open state. After fluid container 15000 is filled, the filling tube is heated and squeezed or pinched until the port is closed and sealed as shown. First port 15010, second port 15050 and third 15090 are rigidly connected to a rigid base 15006 on fluid container body 15005. First port 15010 can be used as the add port and set port if the drug is hazardous. Second port 15050 can be used as the add port with a cannula or a suitable adapter (e.g., with a needle-free access, a vial adapter device) and set port with an IV 20) spike according, for instance, to ISO 8536-4, if the drug is non-hazardous.

The foregoing examples of fluid containers, container ports, fluid transfer devices and fluid transfer systems are non-limiting and do not represent the only containers, ports, devices and systems that are contemplated. Numerous variations, changes, substitutions and combinations will occur to those skilled in the art without departing from the scope of the present disclosure and its teachings, and are part of the present disclosure. This includes a substitution of a feature shown in one example with a feature shown in another example, or a combination of a feature shown in one example with a feature shown in another example. Moreover, the foregoing examples of fluid containers, container ports, fluid transfer devices and fluid transfer systems, and variants thereof, can be used in combination with any CSTDs described in the present disclosure or their respective components. All substitutions, iterations, and combinations are considered part of this written description.

What is claimed:

1. A fluid container comprising:
a container body defining an interior volume;
a port providing access to the interior volume from outside of the container body;
the port comprising a dry break for forming a dry break coupling with a second device.

2. The fluid container according to claim 1, wherein the dry break comprises an adaptor body and a septum configured to form the dry break coupling with the second device.

3. The fluid container according to claim 2, wherein the port comprises a membrane that fluidly separates the interior volume of the container body from the septum.

4. The fluid container according to claim 3, wherein the membrane is directly adjacent to the membrane.

5. The fluid container according to claim 2, wherein the adaptor body comprises a housing portion having a rectangular cross section.

6. The fluid container according to claim 5, wherein the adaptor body comprises a chamber adjacent to the housing portion, the chamber defining a seat for the septum.

7. The fluid container according to claim 6, wherein the adaptor body comprises a first end with a first opening, a second end with a second opening opposite the first opening, and a passage extending from the first opening to the second opening.

8. The fluid container according to claim 7, wherein the passage comprises a first section adjacent the first opening that defines a socket and a second section adjacent the second opening that defines the chamber.

9. The fluid container according to claim 8, wherein the port comprises a plug that is received in the socket.

10. The fluid container according to claim 9, wherein the plug has an outer geometry that conforms to a frustum of a cone.

11. The fluid container according to claim 10, wherein the socket defines a tapered inner wall that conforms to the outer geometry of the plug.

12. The fluid container according to claim 2, wherein the adaptor body comprises a longitudinal axis, a first side and a second side opposite the first side.

13. The fluid container according to claim 12, wherein the first side comprises a first ledge and the second side comprises a second ledge opposite the first ledge.

14. The fluid container according to claim 1, further comprising a second port that provides access to the interior volume from outside of the container body.

15. The fluid container according to claim 14, wherein the second port is not a dry break.

16. The fluid container according to claim 14, wherein the second port comprises a dry break.

17. The fluid container according to claim 1, wherein the port and the dry break are injection molded and connected to each other in a rigid manner.

18. The fluid container according to claim 1, further comprising a flexible tube having a first end and a second end opposite the first end, wherein the first end of the flexible tube is directly welded to the container body and the second end is directly connected to the dry break.

19. A closed fluid transfer system comprising:
A. a fluid container comprising:
a container body defining an interior volume;
a port providing access to the interior volume from outside of the container body; and
a dry break defining a first passage in fluid communication with the port, the dry break comprising a first septum that seals the first passage,
B. a closed system transfer device comprising:
a housing defining an interior space configured to receive at least a portion of the dry break;
a carrier movable in the interior space of the housing, the carrier defining a second passage and comprising a second septum that seals the second passage; and
a cannula at least partially disposed in the second passage, the cannula having a cannula opening.

20. The closed fluid transfer system according to claim 19, wherein the carrier is axially displaceable in the interior space, and relative to the cannula, by the dry break when the dry break is inserted into the housing.

21. The closed fluid transfer system according to claim 20, wherein the carrier is axially displaceable within the housing between a first position, in which the first septum abuts the second septum and the cannula opening is sealed inside the second passage, and a second position, in which the first septum abuts the second septum and the cannula opening is in fluid communication with the first passage of the dry break to connect the fluid container and the closed system transfer device in a fluid path open state.

22. The closed fluid transfer system according to claim 19, wherein the housing comprises a first end and a second end opposite the first end, the first end adapted to receive the portion of the dry break, and the second end configured to connect to at least one fluid reservoir.

23. The closed fluid transfer system according to claim 19, wherein the housing comprises a first end and a second end opposite the first end, the first end adapted to receive the portion of the dry break, and the second end configured to connect to a patient line.

24. The closed fluid transfer system according to claim 19, further comprising a second port that provides access to the interior volume from outside of the container body.
